(19) United States
(12) Patent Application Publication
(10) Pub. No.: US 2024/0408566 A1
(43) Pub. Date: Dec. 12, 2024

(54) COMPOSITION AND METHODS FOR MAKING GLASS CERAMIC POROUS STRUCTURES

(71) Applicant: CORNING INCORPORATED, CORNING, NY (US)

(72) Inventors: Guohua Chen, Painted Post, NY (US); Weimin Hou, Shanghai (CN); He Jing, Clayton, MO (US); Jia Liu, Painted Post, NY (US); Jianguo Wang, Shenzhen (CN); John Forrest Wight, JR., Corning, NY (US); Qing Zhou, Shanghai (CN)

(21) Appl. No.: 18/704,549

(22) PCT Filed: Oct. 24, 2022
(86) PCT No.: PCT/US2022/047524

§ 371 Date: Apr. 25, 2024

(30) Foreign Application Priority Data
Oct. 29, 2021 (CN) 202111268788.0

(51) Int. Cl. B01J 20/16; B01D 46/10; B01D 46/24; B01D 53/02; B01J 20/28; B01J 20/30

(52) U.S. Cl. CPC B01J 20/16; B01D 46/10; B01D 46/2418; B01D 53/02; B01J 20/28085; B01J 20/3042; B01J 20/3064; B01J 20/3078; B01D 2253/106; B01D 2253/25; B01D 2257/504

(57) ABSTRACT

Porous structures are made from compositions that include hollow glass bodies and an inorganic powder. The inorganic powder may act as a rigid frame member, a crystallization agent, or both, which reduces the shrinkage of the porous structures during firing. The porous structures made therefrom have an open porosity of greater than 70% and reduced shrinkage of less than 10% compared to the green structures prior to firing. Methods for firing the green structures made from the compositions are also disclosed, the firing methods including reducing a temperature ramping rate of the green structures during a crystallization temperature range of the glass of the hollow bodies.

### CROSS-REFERENCE TO RELATED APPLICATIONS

This application claims the benefit of priority under 35 U.S.C. § 119 of Chinese Patent Application Serial No. 202111268788.0 filed on Oct. 29, 2021, the content of which is relied upon and incorporated herein by reference in its entirety.

### BACKGROUND

### Field

The present disclosure generally relates to filter materials, more specifically, to porous structures made from hollow glass bodies.

### Technical Background

In recent years, particulate matter (PM) pollution has been recognized as one of the greatest environmental threats facing human societies. The economic impact of PM pollution was estimated to be 2.2 trillion dollars, or 3% of the global economic output. Particulate matter or PM refers to fine and ultrafine particles suspended in air, which are often classified by their sizes, such as PM10 for particles with diameter less than or equal to 10 microns and PM2.5 for particles having diameters less than or equal to 2.5 microns. The smaller the particles, the more damaging they are to human health.

To combat the detrimental effects, PM can be reduced and/or captured at the sources of the PM before they released to the environment. Even for concentrated sources of PM where pollution abatement is adopted, existing technologies are often inadequate. For example, with state-of-the-art technologies, PM2.5 emissions are ˜5000 μg/m³ from power plants and ˜4500 μg/m³ from diesel vehicles, which exceed the World Health Organization's guideline of annual mean PM2.5 of 10 μg/m³ by more than two orders of magnitude. Therefore, there is an urgent need to develop technologies to capture PMs from ambient air at large scales.

Applications for PM capture can be categorized into three major segments: indoor, enclosed spaces (e.g. subway stations, underground garages, etc), and outdoor. For the latter two segments, there is currently no incumbent technology that has proven to be technologically and economically effective at the relevant scales. For indoor applications such as HVAC systems, fabric filters have been widely used to remove dust from ambient air entering buildings, vehicles, etc. Fabric filters can be made from natural fibers (e.g. cotton, wool, etc.) or synthetic fibers (e.g. polymer fibers, glass fibers, etc.). There are various grades of fabric filters designed to capture coarse, medium, and fine particulates. Even though fabric filters are relatively inexpensive, they have limited dust capacity and as dust loading increases, the back pressure increases rapidly and the filters have to be replaced frequently. Because fabric filters cannot be regenerated or reused, filter costs add up in the long term and large amounts of solid waste is generated.

In the last few decades, ceramic honeycomb wall flow filters have been developed and integrated in engine after-treatment systems to capture fine particulates from diesel and gasoline engine exhausts. The ceramic honeycomb filters have several advantages compared to fabric filters, including significantly larger dust capacity, lower pressure drop and in turn, lower energy consumption over the lifetime of filters, regenerability, long lifetime, less solid waste, and lower cost of ownership over the life cycle. The filters discussed above are generally Cordierite-based. For PM capture from ambient air, it is desirable to develop lower-cost honeycomb filters with comparable or greater performance compared to the Cordierite-based filters.

### SUMMARY

The present disclosure is directed to ceramic filters comprising porous structures made from hollow bodies, such as hollow glass bodies. Tiny hollow glass bodies, also called glass bubbles, microballoons, or hollow glass “microspheres,” are commercially available, such as from Dennert Poraver GMBH, 3M, Zhongke Yali Technology, Ltd, Fibre Glast Developments Corp., Potters Industries LLC, and others. Such hollow glass bodies have been used as filler in composite materials, such as concrete. These hollow glass bodies are generally fragile and conventional practices teach methods to prevent breakage of the hollow glass bodies so as to maintain internal closed cavities of the hollow glass bodies, thereby preserving the correspondingly low weight-to-volume relationships that the hollow glass bodies may provide. When the integrity of the hollow glass bodies is maintained, the hollow glass bodies may be integrated into composite materials for buoyant, load-bearing structures, such as surfboards or supports for offshore drilling equipment.

Despite their conventional uses, Applicant has discovered that these hollow bodies comprising glass can be arranged and processed to make particularly efficient porous structures with open porosity, which may be used as filters for removing particulates from ambient air or as porous media for adsorption/desorption units in carbon dioxide capture processes. Structures with open porosity may be formed from tightly packing the hollow bodies together, bonding the hollow bodies to one another, and also breaching the hollow bodies (e.g., breaking popping, fracturing, opening, exposing hollow cores thereof) to produce voids in the porous structure. These voids of the individual hollow bodies may open into one another to form porous cavities that extend and interconnect through the overall porous structure and may open to surfaces thereof. Such porous structures may be particularly useful with filters, or may be used for other purposes, such as providing a glass skeleton infiltrated with polymer, for example.

Bonding and then breaching the hollow bodies may be accomplished by firing a green structure comprising the hollow bodies to temperatures greater than a softening temperature of the glass of the hollow bodies. However, viscous flow of the glass above the softening temperature and/or melting temperature and densification of the glass at the peak firing temperature may cause a significant amount of shrinkage of the porous structure (up to or exceeding 15%) compared to the size of the green structure.

The present disclosure is directed to compositions and methods for decreasing the shrinkage of the green structures comprising hollow bodies during firing. In particular, the present disclosure is directed to compositions that include the hollow bodies and an inorganic powder that can act as a rigid frame member or as a crystallization agent to reduce shrinkage during firing. The hollow bodies may be hollow glass bodies. Additionally or alternatively, the present disclosure includes methods of firing the green structures to reduce the shrinkage of the green structures during firing. In particular, a firing process of the present disclosure may include reducing a temperature ramping rate to less than 100° C./hour within a crystallization temperature range of the composition comprising the hollow bodies. The reduced temperature ramping rate throughout the crystallization temperature range may promote greater crystallization of the glass, which may hinder viscous flow of the glass.

According to a first aspect of the present disclosure, a composition for producing porous structures includes from 5 weight percent (wt. %) to 95 wt. % hollow bodies, from 5 wt. % to 95 wt. % inorganic powder, at least one binder, and water. The hollow bodies may comprise hollow glass bodies. The weight percent is based on the total combined weight of the hollow glass bodies and the inorganic powder.

A second aspect of the present disclosure may include the first aspect, comprising from 50 volume percent (vol. %) to 99 vol. % hollow bodies and from 1 vol. % to 50 vol. % inorganic powder based on the combined true volume of the hollow bodies and the inorganic powder.

According to a third aspect of the present disclosure, a composition for producing porous structures includes from 50 vol. % to 99 vol. % hollow bodies, from 1 vol. % to 50 vol. % inorganic powder, at least one binder, and water. The hollow bodies may comprise hollow glass bodies. The volume percent is based on the combined true volume of the hollow bodies and the inorganic powder.

A fourth aspect of the present disclosure may include any one of the first through third aspects, wherein the inorganic powder may have a median particle size of less than or equal to 0.5 times a median particle size of the hollow bodies.

A fifth aspect of the present disclosure may include any one of the first through fourth aspects, wherein the inorganic powder may comprise a single inorganic powder that acts as one or more of a rigid frame material, a crystallization agent, a reactive agent, or combinations of these.

A sixth aspect of the present disclosure may include any one of the fourth through fifth aspects, wherein the inorganic powder may comprise a rigid frame material, a crystallizing agent, reactive agent, or a combination of these.

A seventh aspect of the present disclosure may include any one of the first through sixth aspects, wherein the inorganic powder may include a rigid frame material comprising one or more powders selected from the group consisting of alumina, silica, titania, zirconia, cordierite, mullite, spinel, forsterite, wollastonite, clinoenstatite, diopside, zircon, sapphirine, clay, SiC, Al₄C₃, ZrC, Si₃N₄, AlN, and combinations of these.

An eighth aspect of the present disclosure may include any one of the first through seventh aspects, wherein the inorganic powder may comprise a rigid frame material that is capable of maintaining its original particle shape at temperatures greater than the softening temperature of the hollow bodies, has a melt temperature greater than the softening temperature of the hollow bodies, or both.

A ninth aspect of the present disclosure may include any one of the first through eighth aspects, wherein the inorganic powder may comprise a rigid frame material that is capable of maintaining its original particle shape at temperatures greater than the crystallization temperature of the hollow bodies, has a melt temperature greater than the crystallization temperature of the hollow bodies, or both.

A tenth aspect of the present disclosure may include any one of the first through ninth aspects, wherein the inorganic powder may include a crystallizing agent or a reactive agent capable of reacting with the glass of the hollow bodies to form new crystal phases at temperatures less than a softening temperature of the hollow bodies.

An eleventh aspect of the present disclosure may include any one of the first through tenth aspects, wherein the inorganic powder may include a crystallizing agent or a reactive agent comprising one or more powders selected from the group consisting of MgO, Mg(OH)₂, CaO, K₂O, Na₂O, KOH, NaOH, CaCO₃, B₂O₃, B(OH)₃, BN, B₄C, TiO₂, talc, clay, forsterite, wollastonite, clinoenstatite, diopside and combinations of these.

A twelfth aspect of the present disclosure may include any one of the first through eleventh aspects, wherein the hollow bodies may comprise silica glass microspheres.

A thirteenth aspect of the present disclosure may include any one of the first through twelfth aspects, wherein the hollow bodies may comprise from 50 wt. % to 85 wt. % silica based on the total weight of the hollow bodies.

A fourteenth aspect of the present disclosure may include any one of the first through thirteenth aspects, wherein the hollow bodies may have a D50 of from 1 μm to 100 μm and a size distribution of less than 0.8, where the size distribution is defined as the quotient of (D50−D10)/D50.

A fifteenth aspect of the present disclosure may include any one of the first through fourteenth aspects, wherein the hollow bodies may have a wall thickness of from 0.2 μm to 10 μm.

A sixteenth aspect of the present disclosure may include any one of the first through fifteenth aspects, wherein the binder comprises cellulose, cellulose derivative, polymer binders, or combinations of these.

A seventeenth aspect of the present disclosure may include any one of the first through sixteenth aspects, comprising from 5 wt. % to 20 wt. % binder based on a combined weight of the hollow bodies and the inorganic powder.

An eighteenth aspect of the present disclosure may include any one of the first through seventeenth aspects, further comprising one or more additives selected from the group consisting of sodium stearate, oil, graphite, starch, and combinations of these.

A nineteenth aspect of the present disclosure may include any one of the first through eighteenth aspects, comprising from 25 wt. % to 100 wt. % water based on a combined weight of the hollow bodies and the inorganic powder.

A twentieth aspect of the present disclosure may include any one of the first through nineteenth aspects, wherein the composition may have a peak firing temperature less than or equal to 1400° C.

A twenty-first aspect of the present disclosure may include any one of the first through twentieth aspects, wherein the inorganic powder may comprise Na₂O, K₂O, B₂O₃, or combinations of these, and the composition may have a peak firing temperature of from 500° C. to 800° C.

A twenty-second aspect of the present disclosure is directed to a porous structure prepared from the composition of any one of the first through twenty-first aspects.

A twenty-third aspect of the present disclosure may include the twenty-second aspect, comprising from 5 wt. % to 95 wt. % glass based on the total weight of the porous structure and from 5% to 95% inorganic powder based on the total weight of the porous structure.

A twenty-fourth aspect of the present disclosure may include either one of the twenty-second or twenty-third aspects, wherein the porous structure may comprise a size and shape within 15% of a size and shape of a green structure comprising the composition prior to firing.

A twenty-fifth aspect of the present disclosure may include any one of the twenty-second through twenty-fourth aspects, wherein the porous structure may exhibit less than 15% shrinkage compared to a green structure comprising the composition of any of the first through twenty-first aspects prior to firing.

A twenty-sixth aspect of the present disclosure may be directed to a porous structure prepared by the process comprising forming a green structure from the composition of any one of the first through twenty-first aspects, and firing the green structure to produce the porous structure having a porosity of greater than or equal to 50%, such as from 50% to 85%.

A twenty-seventh aspect of the present disclosure may be directed to a porous structure comprising from 5 wt. % to 95 wt. % hollow bodies based on the total weight of the porous structure and from 5 wt. % to 95 wt. % inorganic powder based on the total weight of the porous structure. The hollow bodies may be hollow glass bodies. The hollow bodies and inorganic powder may be sintered together, and at least a portion of the hollow bodies may be breached. Voids defined within the individual breached hollow bodies may open into one another to form cavities that extend through the porous structure and to outer surfaces thereof. The porous structure may have at least 50% porosity by volume.

A twenty-eight aspect of the present disclosure may include any one of the twenty-second through twenty-seventh aspects, wherein the hollow bodies are hollow glass bodies comprising silica glass.

A twenty-ninth aspect of the present disclosure may include any one of the twenty-second through twenty-eighth aspects, wherein the porous structure may have a D-factor of less than or equal to 0.5, wherein the D-factor is equal to (d₅₀−d₁₀)/d₅₀, d₅₀ refers to a mean pore diameter of the porous structure at which 50% by volume of the open porosity of the porous structure has been intruded by mercury during a porosimetry measurement, and d₁₀ is equal to the pore diameter at which 90% by volume of the open porosity of the porous structure has been intruded by mercury during a porosimetry measurement.

A thirtieth aspect of the present disclosure may include any one of the twenty-second through twenty-ninth aspects, wherein the porous structure may have a median pore size of from 1 μm to 50 μm, or from 8 μm to 20 μm.

A thirty-first aspect of the present disclosure may include any one of the twenty-second through thirtieth aspects, wherein the porous structure may have a porosity of from 50% to 85%.

A thirty-second aspect of the present disclosure may include any one of the twenty-second through thirty-first aspects, wherein the porous structure may have a honeycomb shape comprising a plurality of elongate channels extending through at least a portion of the porous structure.

A thirty-third aspect of the present disclosure may include the thirty-second aspect, wherein the porous structure may have a cell density of less than 400 cells per inch and a web thickness between cells of from 2 mils to 8 mils, where the cell density refers to a number of the elongate channels per square inch of cross-section of the porous structure.

A thirty-fourth aspect of the present disclosure may include any one of the twenty-second through thirty-third aspects, wherein at least some of the glass of the hollow bodies may be devitrified such that the glass comprises crystals.

A thirty-fifth aspect of the present disclosure may include any one of the twenty-second through thirty-fourth aspect, wherein the porous structure may comprise from 5% to 50% amorphous-phase glass.

A thirty-sixth aspect of the present disclosure is directed to a filter comprising the porous structure of any one of the twenty-second through thirty-fifth aspects; a coating supported by the porous structure, wherein the coating is configured to influence, block, and/or attract target particulates; and a housing at least in part surrounding the porous structure and the coating.

A thirty-seventh aspect of the present disclosure is directed to a CO₂ capture process comprising the porous structure of any one of the twenty-second through thirty-fifth aspects.

A thirty-eighth aspect of the present disclosure may include the thirty-seventh aspect, comprising an adsorption/desorption unit and the porous structure may be integrated into the adsorption/desorption unit.

A thirty-ninth aspect of the present disclosure is directed to a method for making a porous structure, the method comprising preparing a composition comprising hollow bodies, an inorganic powder, a binder, and water, where the hollow bodies comprise hollow glass bodies. The method may further include forming a green structure from the composition and firing the green structure. Firing the green structure may bond the hollow bodies and inorganic powder together and breach at least a portion of the hollow bodies to form the porous structure having a size and shape that is within 15%, or even within 1% of a size and shape of the green structure before firing.

A fortieth aspect of the present disclosure may include the thirty-ninth aspect, further comprising tuning an average pore size of the porous structure by changing a proportion of the inorganic powder to the hollow bodies in the composition.

A forty-first aspect of the present disclosure may include either one of the thirty-ninth or fortieth aspects, further comprising changing the porosity of the porous structure by changing an amount of the inorganic powder in the composition.

A forty-second aspect of the present disclosure may include any one of the thirty-ninth through forty-first aspects, comprising firing the green structure at a peak firing temperature less than or equal to 1400° C.

A forty-third aspect of the present disclosure may include the forty-second aspect, wherein firing the green structure at the peak firing temperature may comprise ramping the green structure to the peak firing temperature and holding the green structure at the peak firing temperature for a period of from 1 hour to 10 hours.

A forty-fourth aspect of the present disclosure may include any one of the thirty-ninth through forty-third aspects, further comprising stacking a plurality of green bodies formed from the composition and then firing the stacks of green bodies.

A forty-fifth aspect of the present disclosure may include any one of the thirty-ninth through forty-fourth aspects, wherein firing may comprise holding the green structure at a crystallization temperature of the glass or slowing a temperature ramping rate of the green structure at the crystallization temperature or in a crystallization temperature zone of the glass.

A forty-sixth aspect of the present disclosure may include any one of the thirty-ninth through forty-fifth aspects, wherein firing the green structure comprises de-binding the green structure in a temperature range of from 200° C. to 400° C.; ramping the temperature of the green structure to a crystallization temperature of the hollow bodies at a first ramping rate of from 50° C. per hour to 300° C. per hour; at a crystallization start temperature, slowing the temperature ramp rate to a second ramping rate of less than 100° C. per hour or holding the temperature at the crystallization start temperature for a time period of 1 hour to 10 hours, wherein slowing the ramping rate at the crystallization start temperature or holding the green structure at the crystallization start temperature reduces shrinkage of the porous structure compared to the green structure; ramping the green structure to a peak firing temperature of the green structure; and maintaining the green structure at the peak firing temperature for a period of from 1 hour to 10 hours.

A forty-seventh aspect of the present disclosure may include the forty-sixth aspect, wherein de-binding the green structure comprises heating the green structure to a temperature in a de-bind temperature range of from 200° C. to 400° C. and maintaining the green structure at the temperature in the de-bind temperature range or ramping the temperature of the green structure at a ramping rate of less than 50° C./min through the temperature range of from 200° C. to 400° C.

A forty-eighth aspect of the present disclosure may include any one of the thirty-ninth through forty-seventh aspects, further comprising cooling the porous structure to room temperature.

A forty-ninth aspect of the present disclosure may include any one of the thirty-ninth through forty-eighth aspects, wherein forming the green structure comprises extrusion, molding, injection molding, 3D printing, tape casting, rolling, calendaring, or combinations of these.

A fiftieth aspect of the present disclosure may include any one of the thirty-ninth through forty-ninth aspects, wherein the porous structure may comprise a median pore size of from 1 μm to 50 μm, or from 8 μm to 20 μm.

A fifty-first aspect of the present disclosure is directed to a method for preparing a porous structure, the method comprising forming a composition to produce a green structure, wherein the composition comprises hollow glass bodies, a binder, and water. The method may further include firing the green structure to produce the porous structure. Firing may include heating the green structure to a de-bind temperature of from 200° C. to 400° C., maintaining the green structure at the de-bind temperature for a period of from 1 hour to 10 hours, and ramping the temperature of the green structure to a first temperature less than a lower crystallization temperature of the hollow bodies at a first ramping rate of from greater than 50° C. per hour to 300° C. per hour. The method may further include, at a first temperature, slowing the temperature ramp rate to a second ramping rate of less than 100° C. per hour wherein the second ramping rate is less than the first ramping rate and slowing the ramping rate at the first temperature provides greater time for crystallization and reduces shrinkage of the porous structure compared to the green structure. The method may further include ramping the green structure to a peak firing temperature of the green structure and maintaining the green structure at the peak firing temperature for a period of from 1 hour to 10 hours.

A fifty-second aspect of the present disclosure may include the fifty-first aspect, comprising maintaining the temperature ramp rate at the second ramping rate until the temperature of the green form reaches the peak firing temperature.

A fifty-third aspect of the present disclosure may include either one of the fifty-first or fifty-second aspects, wherein ramping the green structure to the peak firing temperature of the green structure may comprises ramping the temperature of the green structure at the second ramping rate until the temperature of the green structure reaches a second temperature, wherein the second temperature may be greater than a lower crystallization temperature of the glass; maintaining the green structure at the second temperature for a soak duration of from 1 hour to 10 hours; and ramping the temperature of the green structure up to the peak firing temperature at a third ramping rate.

A fifty-fourth aspect of the present disclosure may include any one of the fifty-first through fifty-third aspects, further comprising cooling the porous structure after maintaining the green structure at the peak firing temperature.

A fifty-fifth aspect of the present disclosure may include the fifty-fourth aspect, wherein cooling comprises ramping the temperature down to room temperature over a period of from 1 hour to 10 hours.

A fifty-sixth aspect of the present disclosure may include any one of the fifty-fourth through fifty-fifth aspects, wherein cooling comprises cooling the porous structure to an annealing temperature of a glass of the hollow bodies, holding at the annealing temperature for an annealing time of from 1 hour to 10 hours, and cooling the porous structure from the annealing temperature to room temperature.

A fifty-seventh aspect of the present disclosure may include any one of the fifty-first through fifty-sixth aspects, wherein the porous structure has a shrinkage of less than 15% compared to the green structure prior to firing.

Additional features and advantages of the subject matter described and claimed herein will be set forth in the detailed description that follows, and in part will be readily apparent to those skilled in the art from that description or recognized by practicing the embodiments described herein, including the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a perspective view, in partial cross-section, of a filter comprising a porous structure, according to one or more embodiments shown and described herein;

FIG. 2 schematically depicts a perspective view of the porous structure shown in FIG. 1, according to one or more embodiments shown and described herein;

FIG. 3 schematically depicts a perspective view of another porous structure, according to one or more embodiments shown and described herein;

FIG. 4 graphically depicts a percent shrinkage (y-axis) as a function of temperature during firing (x-axis) for green structure made with hollow glass microspheres only, according to one or more embodiments shown and described herein;

FIG. 5A graphically depicts a Scanning Electron Microscope (SEM) image of a particle morphology of hollow glass bodies during a glass softening phase at firing temperatures of from 570° C. to 770° C. for a porous structure made with hollow glass bodies only, according to one or more embodiments shown and described herein;

FIG. 5B graphically depicts an SEM image of the particle morphology of the hollow glass bodies during a crystallization phase at temperatures of from 770° C. to 970° C. for the porous structure of FIG. 5A, according to one or more embodiments shown and described herein;

FIG. 5C graphically depicts an SEM image of the particle morphology of the hollow glass bodies during densification and grain growth at temperatures of greater than 970° C. for the porous structure of FIGS. 5A and 5B, according to one or more embodiments shown and described herein;

FIG. 6 graphically depicts high-temperature X-Ray Diffraction (XRD) results (y-axis) as a function of firing temperature (x-axis) for the porous structure of FIGS. 5A, 5B, and 5C, according to one or more embodiments shown and described herein;

FIG. 7 graphically depicts high-temperature XRD results (y-axis) as a function of firing temperature (x-axis) for a green structure comprising hollow glass bodies and Al₂O₃ as the inorganic powder, according to one or more embodiments shown and described herein;

FIG. 8 graphically depicts high-temperature XRD results (y-axis) as a function of firing temperature (x-axis) for a green structure comprising hollow glass bodies and magnesium oxide (MgO) as the inorganic powder, according to one or more embodiments shown and described herein;

FIG. 9 graphically depicts shrinkage of porous structures (y-axis) as a function of a proportion of MgO in the composition (x-axis), according to one or more embodiments shown and described herein;

FIG. 10A schematically depicts a packing pattern of hollow glass bodies and an inorganic powder having a small average particle size relative to the hollow glass bodies, according to one or more embodiments shown and described herein;

FIG. 10B schematically depicts a packing pattern of hollow glass bodies and an inorganic powder having a larger particle size that is a particle size similar to that of the hollow glass bodies, according to one or more embodiments shown and described herein;

FIG. 11 graphically depicts shrinkage (y-axis) as a function of volume percentage of inorganic powder (x-axis) for porous bodies, according to one or more embodiments shown and described herein;

FIG. 12 graphically depicts compressive stress (y-axis) obtained from modulus of rupture testing of porous structures made from various composition comprising hollow glass bodies with and without inorganic powder, according to one or more embodiments shown and described herein;

FIG. 13 graphically depicts firing temperature (y-axis) as a function of time (x-axis) for the porous structures of Example 15, according to one or more embodiments shown and described herein;

FIG. 14 graphically depicts a porosity (y-axis), a median pore diameter (y-axis), and D-Factor (y-axis) for porous structures prepared from hollow glass bodies as a function of peak firing temperature (x-axis), according to one or more embodiments shown and described herein;

FIG. 15 graphically depicts a relative height (y-axis left) and temperature (y-axis right) as functions of time (x-axis) for a green structure fired with a normal temperature ramping rate, according to one or more embodiments shown and described herein;

FIG. 16A depicts a photograph of a honeycomb shaped green structure prior to firing according to one or more embodiments shown and described herein;

FIG. 16B depicts a photograph of the porous structure resulting from firing of the honeycomb-shaped green structure of FIG. 16A, according to one or more embodiments shown and described herein;

FIG. 17 graphically depicts high temperature XRD results for wt. % crystallinity (y-axis) as a function of temperature (x-axis) for two green structures fired at different constant temperature ramping rates, according to one or more embodiments shown and described herein;

FIG. 18 graphically depicts shrinkage (y-axis), porosity (y-axis), median pore size (y-axis), and pore size distribution (y-axis) of the final porous structure after firing as a function of the temperature ramping rate (x-axis), according to one or more embodiments shown and described herein;

FIG. 19 graphically depicts temperature (y-axis) as a function of time (x-axis) for a firing process with a reduced temperature ramping rate in the crystallization temperature range and a crystallization dwell time, according to one or more embodiments shown and described herein; and

FIG. 20 graphically depicts temperature (y-axis) as a function of time (x-axis) for a firing process with a reduced temperature ramping rate in the crystallization temperature range and no crystallization dwell time, according to one or more embodiments shown and described herein.

FIG. 21 graphically depicts an an example of a system for conducting CO2 capture process experiments, according to one or more embodiments shown and described herein.

### DETAILED DESCRIPTION

Reference will now be made in detail to various embodiments of the compositions, porous structures, and methods of the present disclosure. Whenever possible, the same reference numerals will be used throughout the drawings to refer to the same or like parts. In embodiments, a composition for producing porous structures may include from 50 vol. % to 99 vol. % hollow bodies and from 1 vol. % to 50 vol. % inorganic powder based on the combined true volume of the hollow bodies and the inorganic powder. The hollow bodies may include hollow glass bodies. The composition may further include at least one binder and water. The inorganic powder may act as a rigid frame member and/or a crystallization agent, which may reduce shrinkage of green structures made from the composition during firing to produce the porous structures.

As used herein, the term “hollow bodies” refers to particles comprising a shell that is made of glass and that surrounds an internal volume containing a substance that is not glass, such as air or other gas.

As used herein, the term “green structure” refers to a structure formed of the compositions disclosed herein that has not been subjected to firing.

As used herein, the term “peak firing temperature” refers to the maximum temperature during the firing process, at which maximum temperature, the green structure is maintained for a period of time before being gradually cooled down to ambient temperature.

As used herein, the term “dwell” or “dwell period” may refer to one or more periods of time during a firing process when the temperature of the green structures are maintained relatively constant, such as maintaining the temperature of the green structures within a specified range about a target temperature.

As used herein, the term “lower crystallization temperature” of a composition, such as a glass composition, may refer to a temperature at which one or more constituents of the composition begin to undergo devitrification and/or crystallization.

As used herein, the term “upper crystallization temperature” of a composition, such as a glass composition, may refer to a temperature at which devitrification slows significantly and crystallization proceeds at an insignificant rate.

As used herein, the term “crystallization temperature zone” refers to the temperature range between the crystallization zone lower temperature and the crystallization zone lower temperature.

As used herein, the term “cell density” refers to the number of elongate channels of a honeycombed shaped porous structure per unit cross-sectional area of the honeycombed porous structure and is provided in units of cells per square inch. A cell refers to the transverse cross-section of an elongate channel.

Referring to FIG. 1, an assembly, shown as a filter 110, includes the porous structure 112 (e.g., substrate, body) in the form of a honeycomb and a housing 114 (e.g., frame), such as a metal can. The housing 114 is at least in part surrounding the porous structure 112. More specifically, FIG. 1 shows the housing 114 in partial cross-section, with a portion removed to show the porous structure 112 contained within the housing 114. In embodiments, the porous structure 112 may be coated, such as with a coating configured to attract or otherwise influence target particulates (e.g., exhaust emissions, air particulates, volatile organic compounds). For example, a porous structure 112 in a catalytic converter assembly may receive washcoats or coatings that may include but are not limited to aluminum oxide, titanium and silicon dioxides. In embodiments, the porous structure 112 in a catalytic converter assembly may be coated with catalysts that include but are not limited to precious metals, such as platinum, rhodium, or other catalytic metal.

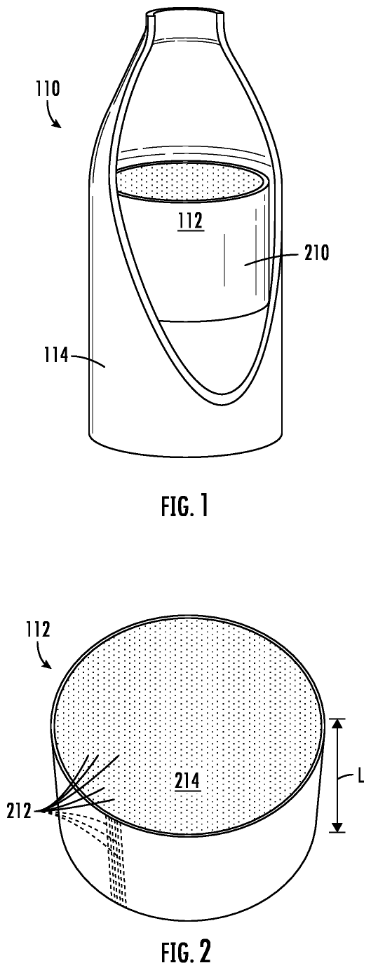

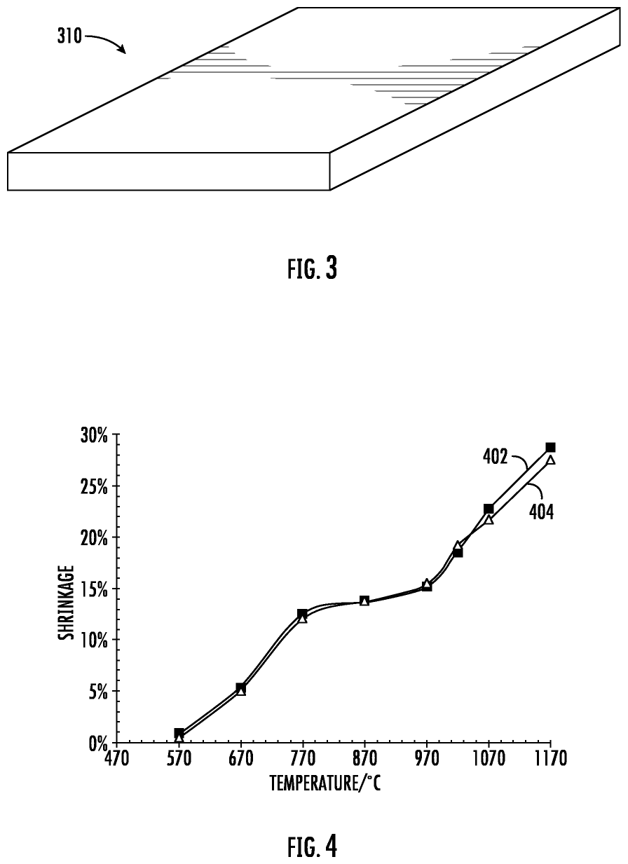

Referring to FIG. 2, the porous structure 112 may be used in a filter 110 or otherwise. The porous structure 112 may be a “honeycomb” in that the porous structure 112 may include elongate channels 212 that extend generally through at least a portion of the porous structure 112, such as extending linearly from an outer surface 214 (e.g., face) of the porous structure 112 to or near an opposing outer surface of the porous structure 112. In embodiments, the filter 110 may include plugs (not shown) where air flows through walls and webs of the filter, but particulates are caught. The plugs may force fluid flow from one channel, through the pores in the walls of the porous structure, and into another adjacent channel. Flow of the fluid through the pores of the porous structure may enable particulates entrained in the fluid to get caught in the pores, thereby removing the particulates from the fluid flow (e.g., removing particulars from a gas or air flow). In embodiments, some or all of the elongate channels 212 may be unplugged, allowing fluids (e.g., exhaust, water, etc.) to flow through the elongate channels 212. In still other embodiments, the porous structure 112 may be porous but not include elongate channels 212 (see generally FIG. 3, which schematically depicts a porous structure 310 comprising a rectangular prism with no channels extending therethrough).

Referring again to FIG. 2, when present, the elongate channels 212 may have relatively high aspect ratios, such as length-to-width ratio or length-to-diameter ratio, where length L is oriented along (i.e., parallel to) the flow path of the elongate channels 212 between openings on the outer surface 214 provided by the elongate channels 212 on opposing outer surfaces 214 of the porous structure 112, as shown in FIG. 2. The elongate channels 212 are elongate such that the aspect ratio, defined as the length of an elongate channel 212 in relation to widest cross-sectional dimension of the respective elongate channel 212 orthogonal to the length L (e.g., L divided by the diameter of the channel for channels having circular cross-sections), of at least some of (e.g., most, >90%, all) the channels is greater than or equal to 10, greater than or equal to 20, greater than or equal to 50, greater than or equal to 100, and less than or equal to 50,000.

While FIGS. 1-2 show porous structures 112 having a generally cylindrical geometry, other geometries are contemplated, such as cube, box, sheet, or more complex geometries. For example, referring now to FIG. 3, porous structure 310 may be generally a rectilinear sheet, which may be used as a filter substrate or for other purposes. In embodiments, the porous structure 310 of FIG. 3 may have a generally uniform density and heterogeneous pore distribution, essentially a sheet of glass foam, without elongate channels. In embodiments, the glass foam may be highly porous, coated, and/or partially- or fully-filled with liquid material (e.g., electrolyte), solid material (e.g., dielectric), or otherwise.

According to embodiments, the porous structure 310 may be highly porous, and the pores (e.g., cavities, voids, space between structures) are open to one another such that fluids may pass through the pores, into and through the porous structure 310. However, the porous structure 310 may be only semi-permeable, in some such embodiments, allowing only some fluids and/or smaller particulates to pass through the porous structure 310, but trapping or blocking others.

According to embodiments, the porous structures 112 and 310, in terms of weight, may comprise a significant proportion of glass or crystallized glass, such as at least 25% of the weight, at least 40%, at least 45%, at least 50%, at least 55%, at least 60%, at least 65%, at least 70%, at least 75%, at least 80%, at least 85%, at least 90%, at least 95%, or even at least 98% by weight glass or crystallized glass based on the total weight of the porous structure. Such large portions of the structures 112, 310 formed from glass or crystallized glass of the hollow glass bodies may be surprising or counterintuitive for those in industry because they may expect such structures to be particularly fragile and/or not hold together at all. However, in some contemplated uses, the porous space of the porous structures 112, 310 may later be at least partially filled by other materials (e.g., fluids), while the porous structures 112, 310 largely hold together due to methods of making such structures as taught herein.

Honeycomb-shaped porous structures 112, 310 made from hollow bodies comprising glass materials may provide superior microstructures having greater than 50% porosity, tunable pore size, and narrow pore size distribution, which may make the porous structures ideal for incorporation into wall flow filters. However, honeycomb shaped porous structures made from hollow bodies comprising glass materials as the sole or only inorganic constituent exhibit significant shrinkage during the firing process. The shrinkage of the porous structures can be as much as ˜15% linear shrinkage compared to the starting green structure, depending on the firing cycle. Such high shrinkage can potentially affect the final porous structure product and process negatively in several different ways: (1) lower total porosity than would otherwise be possible if shrinkage were lower; (2) significantly different geometry with respect to cell density (cells per square inch (cpsi)) and web thickness of the porous structure compared to the green structure obtained from the extrusion die; (3) greater propensity for part deformation, distortion, and/or cracking during processing; and (4) greater manufacturing cost on the per unit volume basis. Additionally, green structures made from compositions comprising the hollow bodies comprising glass as the only inorganic constituent can exhibit sticking to the refractory bricks that support the green structures during firing and sticking to each other when stacked during firing. Sticking to the refractory or to each other can increase the defect rate during firing and prohibit stacking the green structures, which limits the number of green structures per firing cycle.

The present disclosure is directed to compositions and methods for producing porous structures, such as glass ceramic and/or ceramic honeycomb-shaped porous structures, where the compositions and methods reduce shrinkage of the porous structures relative to the green structures prior to firing. The compositions of the present disclosure may include the hollow bodies comprising glass in combination with an inorganic powder that is not a glass. The hollow bodies may include hollow glass bodies. The inorganic powder added to the composition may act as a rigid frame member, a crystallization agent, or both during firing of the green structure made from the composition, which may reduce shrinkage of the green structures during firing. The compositions comprising the hollow glass bodies in combination with the inorganic powder may result in less firing shrinkage, greater porosity, tunable pore size, and greater mechanical strength compared to compositions comprising the hollow glass bodies as the sole or only inorganic ingredient (e.g., no added inorganic powder). In addition, the manufacturing cost is expected to be lower due to the combination of several factors, including less volume reduction during firing, reduced material cost, lesser firing temperature, and ability to stack the green structures during firing.

In particular, the compositions comprising the hollow glass bodies in combination with the inorganic powder can reduce the firing shrinkage of the porous structures to less than 10%, less than 5%, less than 3%, less than 2%, or even less than 1% compared to the green structures prior to firing. Less shrinkage can enable greater material usage rate as measured by the volume of substrate or filter products. The presence of the inorganic powder may provide better control of the fired ware geometry and decrease porous structure defects resulting from shrinkage. The inorganic powder may enable the pore size to be tuned by adjusting the packing pattern of hollow glass bodies and inorganic powder particles. The combination of the hollow glass bodies with the inorganic powder can enable a broader range of pore size distribution and a median pore size can be tuned in the range of 1 μm to 50 μm. The compositions comprising the hollow glass bodies and the inorganic powder may also have a reduced peak firing temperature, such as a peak firing temperature of less than 1000° C., such as from 500° C. to 1000° C. or from 800° C. to 970° C., compared to compositions comprising only hollow glass bodies. The presence of the inorganic powder may provide greater mechanical strength to the porous structures, which can facilitate thinner web thicknesses, reduced cell density (cpsi) of honeycomb-shaped porous structures, and make parts handling easier. The inorganic powder may also enable a greater range of glass compositions for the hollow glass bodies to be used, which could lead to lower cost and greater material/process flexibility. The compositions disclosed herein can potentially be fired with parts stacking due to the inorganic powders acting as rigid frame members and/or crystallization agents, which can prevent stacked green structures from sticking to each other and to refractory bricks in the furnace, among other features.

The present disclosure further include methods of firing green structures comprising hollow glass bodies to reduce shrinkage. The firing methods disclosed herein may include reducing the temperature ramping rate of the green structures in a crystallization temperature range of the firing process to a temperature ramping rate of less than 100° C. per hour. Additionally or alternatively, the firing methods may further include holding the green structures at a temperature in the crystallization temperature range for a dwell period. Slowing the temperature ramping rate and/or holding the green structures at a temperature within the crystallization temperature range of the glass may reduce shrinkage by increasing crystallization of the glass, which may hinder the viscous flow of softened glass at temperatures above the softening temperature.

The compositions of the present disclosure include a mixture of hollow glass bodies, an inorganic powder, and water. The compositions of the present disclosure may further include one or more binders, one or more additives, or combinations of these. The compositions of the present disclosure may be formed into green structures and then fired to produce the porous structures. The green structures may refer to pre-fired or pre-sintered structures made from the composition before firing and/or sintering. The green structures may be exterior walls and/or interior walls or web of a porous structure, such as a honeycomb-shaped porous structure as shown in FIG. 1.

The composition disclosed herein includes the hollow bodies, which can be hollow glass bodies. Hollow bodies and hollow glass bodies may be used interchangeably throughout the present specification. The composition of the present disclosure and the porous structures made therefrom may include and/or be at least partially formed from a plurality of hollow bodies, where a “plurality” of hollow bodies may refer to greater than or equal to 100, or even greater than or equal to 1000 hollow bodies. The hollow bodies may act as both a pore former and a main frame structure to provide a high porosity porous structure. The hollow bodies may include a glass shell that encloses a hollow volume. The hollow volume may comprise a gas, such as but not limited to air or other gas. The hollow glass bodies may have various shapes. The hollow bodies may be generally spherical or may have an irregular shape, such as having a potato-shape for example.

The hollow bodies can be characterized by diameter, where the “diameter” may refer to the diameter of the hollow body if the volume of the hollow body was arranged in a perfect spherical geometry. The size of hollow bodies may be selected and characterized based on the diameter, where “D50” particle size corresponds to a 50% pass point of hollow bodies having a diameter of the D50 value, where half in a group are larger and half are smaller in diameter than the D50 value. The hollow bodies may have a D50 of greater than or equal to 1 μm, greater than or equal to 3 μm, greater than or equal to 5 μm, or even greater than or equal to 10 μm. The hollow bodies may have a D50 of less than or equal to 100 μm, less than or equal to 50 μm, or even less than or equal to 40 μm. The hollow bodies may have a D50 of from 1 μm to 100 μm, 1 μm to 50 μm, from 1 μm to 40 μm, from 3 μm to 100 μm, from 3 μm to 50 μm, from 3 μm to 40 μm, from 5 μm to 100 μm from 5 μm to 50 μm, 5 μm to 40 μm, from 10 μm to 100 μm, from 10 μm to 50 μm, or from 10 μm to 40 μm.

The D10 value of the hollow bodies refers to a 10% pass point of the hollow bodies, where only 10% of the hollow bodies have a diameter less than the D10 value. The D90 value of the hollow bodies refers to a 90% pass point of the hollow bodies, where 90% of the hollow bodies have a diameter less than the D90 value. The D10 and D90 values for the hollow bodies may be used to evaluate the particle size distribution of the hollow bodies. The particle size distribution of the hollow bodies may be generally characterized by the expression (D90−D10)/D50. The hollow bodies may have a particle size distribution of less than or equal to 2, less than or equal to 1.5, less than or equal to 1, less than or equal to 0.8, less than or equal to 0.4, less than or equal to 0.2, less than or equal to 0.1, or less than or equal to 0.06, where the size distribution is defined as the quotient of (D90−D10)/D50. In embodiments, the composition may include two or more different types or sizes of hollow bodies. In these embodiments, each type or size of hollow bodies may be characterized by a D50 value and a particle size distribution such that the particle size distribution for the hollow bodies overall in the composition is multi-modal.

The hollow bodies incorporated into the composition and before firing (i.e., before breaching the hollow glass bodies as discussed further herein) may have a density of greater than or equal to 0.1 g/cm³, such as greater than or equal to 0.3 g/cm³, where the density is the mass per volume, which includes the interior bubble volume of the hollow bodies. The hollow bodies incorporated into the composition and before firing may have a density of less than or equal to 1.5 g/cm³, such as less than or equal to 0.7 g/cm³. The hollow bodies before firing may have a density of from 0.1 g/cm³ to 1.5 g/cm³, from 0.1 g/cm³ to 0.7 g/cm³, from 0.3 g/cm³ to 1.5 g/cm³, or from 0.3 g/cm³ to 0.7 g/cm³.

The hollow bodies may have a wall thickness of the shell sufficient to enable the hollow bodies to withstand being formed into green structures, such as through extrusion or molding, but thin enough to enable breaching of a majority of the hollow bodies during firing. The hollow bodies may have an average wall thickness of from 0.2 μm to 10 μm, or from 1 μm to 3 μm.

The hollow bodies may have an isostatic crush strength that is sufficient so that the hollow bodies do not break during the forming process, such as during extrusion. The isostatic crush strength of the hollow bodies depends on the shell thickness, particle size, and glass composition of the hollow bodies. In embodiments, particularly resilient hollow bodies are used, such as those having a mean isostatic crush strength of at least 1000 psi (6.9 MPa), such as at least 2000 psi (13.8 MPa), such as at least 3000 psi (20.7 MPa) (see Measuring Isostatic Pressing Strength of Hollow Glass Microspheres by Mercury-injection Apparatus by Yun and Shou, Key Engineering Materials, vol. 544, pp. 460-5 (2013)).

The hollow bodies may include glass (e.g., consist of, consist mostly of by volume, comprise), such as silica glass, soda lime glass, borosilicate, or other glasses. In embodiments, the hollow bodies may comprise silica glass microspheres. The glass of the hollow bodies may be fully amorphous. In embodiments, the glass of the hollow glass bodies may be amorphous prior to heating, and subsequently may devitrify and/or crystallize during the firing process. For clarity, “glass” as used herein includes amorphous glass and/or at least partially devitrified glass with crystals.

According to embodiments, hollow glass bodies with high crystallinity at softening temperatures of the hollow glass bodies, such as hollow glass bodies including more than 45% silica (SiO₂) and/or CaSiO₃, etc. by weight, facilitate transformation processes from internal porosity to open connected porosity, as discussed below. The glass composition constituents may include more than 50 wt. % SiO₂, such as from 50 wt. % to 85 wt. %, from 50 wt. % to 80 wt. %, from 74 wt. % to 85 wt. % SiO₂, or from 74 wt. % to 80 wt. % SiO₂ based on the total weight of the glass. In embodiments, the glass of the hollow glass bodies may additionally include more than 6.5% CaO, less than 7% and at least some B₂O₃, less than 1% and at least some Al₂O₃, at least some Fe₂O₃, less than 2.5% and at least some Na₂O, and/or at least some K₂O. In embodiments, the glass of the hollow glass bodies is, is mostly, or includes soda lime, borosilicate, and/or aluminum silicate glass. Some exemplary glass compositions and corresponding attributes of various hollow glass bodies are provided in Tables 1 and 2.

TABLE 1
Exemplary hollow glass body compositions

| Sample | A1 | A2 | A3 | A4 | A5 | B1 | B2 |
|---|---|---|---|---|---|---|---|
| SiO₂ | 79.4 | 79.3 | 79.3 | 79.3 | 79.5 | 73.6 | 71.1 |
| CaO | 7.72 | 7.43 | 7.43 | 7.43 | 7.89 | 6.19 | 5.67 |
| B₂O₃ | 5.95 | 5.95 | 5.95 | 5.95 | 5.09 | 7.38 | 8.73 |
| Al₂O₃ | 0.52 | 0.55 | 0.55 | 0.55 | 0.49 | 1.01 | 1.07 |
| Fe₂O₃ | 0.057 | 0.056 | 0.056 | 0.056 | 0.035 | 0.089 | 0.081 |
| Na₂O | 1.68 | 1.59 | 1.59 | 1.59 | 1.74 | 2.58 | 2.60 |
| K₂O | 0.14 | 0.14 | 0.14 | 0.14 | 0.14 | 0.19 | 0.21 |

TABLE 2
Attributes of hollow glass bodies

| Sample | A1 | A2 | A3 | A4 | A5 | B1 | B2 |
|---|---|---|---|---|---|---|---|
| Softening | ~800 | ~800 | ~800 | ~800 | ~800 | ~600 | ~600 |
| temp. (° C.) | | | | | | | |
| Density | 0.38 | 0.60 | 0.64 | 0.55 | 0.48 | 0.45 | 0.34 |
| (g/cm³) | | | | | | | |
| Porosity (%) | 82.9 | 73.1 | 71.3 | 75.3 | 78.4 | 79.8 | 84.8 |
| Shell | 1.07 | 1.45 | 1.18 | 1.76 | 0.91 | 0.70 | 1.24 |
| Thickness | | | | | | | |
| (μm) | | | | | | | |
| Particle Size | 21.1 | 17.0 | 15.2 | 27.9 | 15.0 | 10.5 | 21.9 |
| D₁₀ (μm) | | | | | | | |
| Particle Size | 35.5 | 28.7 | 22.2 | 39.1 | 23.4 | 19.2 | 35.1 |
| D₅₀ (μm) | | | | | | | |
| Particle Size | 58.3 | 58.9 | 33.5 | 58.9 | 37.0 | 35.4 | 55.4 |
| D₉₀ (μm) | | | | | | | |
| Distribution | 1.05 | 1.45 | 0.83 | 0.79 | 0.94 | 1.30 | 0.95 |
| (D₉₀ − D₁₀)/ | | | | | | | |
| D₅₀ | | | | | | | |
| Crush | 3000 | 10000 | | | 4000 | 3000 | 4000 |
| strength | | | | | | | |
| (psi) | | | | | | | |

Hollow glass bodies with different compositions can be used. Without the inorganic powder, a crystallization process was needed to maintain structural stability during firing and this may limit the hollow glass bodies to be of some specific compositions. However, with the addition of a second inorganic material (i.e., the inorganic powders disclosed herein) that can provide structural support and/or react with hollow glass bodies as described in the current disclosure, the glass compositions for the hollow glass bodies can be expanded, enabling a broader range of glass compositions to be useful, which could lead to lower cost and greater material/process flexibility, among other benefits.

In embodiments, the composition may include a plurality of different types of hollow glass bodies, such as glass bodies having different glass compositions or different physical attributes. The different physical attributes may include different median or average particle sizes, different softening temperatures, different particle size distribution, different density, different shell thickness, different crush strength, or combinations of these. In embodiments, the composition may include first hollow glass bodies and second hollow glass bodies, where the second glass bodies have one or more of a glass composition, median or average particle size, softening temperature, particle size distribution, density, shell thickness, crush strength, or combinations of these, that is different from the first hollow glass bodies.

The compositions of the present disclosure for making the porous structures may include an amount of the hollow glass bodies sufficient to produce a porous structure having a porosity of greater than or equal to 50% or greater than or equal to 70%. In embodiments, the compositions may include from 50 vol. % to 99 vol. % hollow glass bodies, where the volume percentage refers to the true volume of the hollow glass bodies, including the internal volume within the shell, divided by the combined true volume of the hollow glass bodies and the inorganic powder (e.g., not including the water, binder, or additives). The true volume of the inorganic powder and/or the hollow glass bodies refers to a volume of the particles excluding the inter and intra particulate spaces in a powder, except the true volume of the hollow glass bodies, which includes the internal volume enclosed by the glass shell in this case. The compositions may include from 50 vol. % to 95 vol. %, from 50 vol. % to 85 vol. %, from 50 vol. % to 75 vol. %, from 60 vol. % to 99 vol. %, from 60 vol. % to 95 vol. %, from 60 vol. % to 90 vol. %, from 60 vol. % to 85 vol. %, from 60 vol. % to 75 vol. %, from 75 vol. % to 99 vol. %, or from 75 vol. % to 95 vol. % hollow glass bodies, where the volume percentage refers to the true volume of the hollow glass bodies, including the internal volume within the shell, divided by the combined true volume of the hollow glass bodies and the inorganic powder. The compositions may include from 5 wt. % to 95 wt. % hollow glass bodies, where the weight percentage is based on the total weight of the hollow glass bodies and the inorganic powder. The compositions may include from 5 wt. % to 90 wt. %, from 5 wt. % to 80 wt. %, from 5 wt. % to 70 wt. %, from 25 wt. % to 95 wt. %, from 25 wt. % to 90 wt. %, from 25 wt. % to 80 wt. %, from 25 wt. % to 70 wt. %, from 50 wt. % to 90 wt. %, from 50 wt. % to 80 wt. %, or from 50 wt. % to 70 wt. % hollow glass bodies based on the total weight of the hollow glass bodies and the inorganic powder. In embodiments, the composition may include from 5 wt. % to 95 wt. % hollow glass bodies based on the total weight of the composition (e.g., including water, binder, and additives in addition to the hollow glass bodies and inorganic powder), such as from 5 wt. % to 90 wt. %, from 5 wt. % to 80 wt. %, from 5 wt. % to 50 wt. %, from 5 wt. % to 40 wt. %, from 5 wt. % to 35 wt. %, from 10 wt. % to 95 wt. %, from 10 wt. % to 90 wt. %, from 10 wt. % to 80 wt. %, from 10 wt. % to 50 wt. %, from 10 wt. % to 40 wt. %, from 10 wt. % to 35 wt. %, from 20 wt. % to 95 wt. %, from 20 wt. % to 90 wt. %, from 20 wt. % to 80 wt. %, from 20 wt. % to 50 wt. %, from 20 wt. % to 40 wt. %, or from 20 wt. % to 35 wt. % hollow glass bodies based on the total weight of the composition.

As previously discussed, the compositions for making the porous structures may also include an inorganic powder. The inorganic powder may be a solid particulate material that is not a glass. The inorganic powder may act as a rigid frame member, a crystallizing agent, a reactive agent, or combinations of these to reduce shrinkage during the firing step. The inorganic powder may have a melt temperature greater than the softening temperature of the glass of the hollow glass bodies. In embodiments, the inorganic powder may include but is not limited to alumina, silica, titania, zirconia, cordierite, mullite, spinel, forsterite, wollastonite, clinoenstatite, diopside, zircon, sapphirine, clay, SiC, Al₄C₃, ZrC, Si₃N₄, AlN, MgO, Mg(OH)₂, CaO, K₂O, Na₂O, KOH, NaOH, CaCO₃, B₂O₃, B(OH)₃, BN, B₄C, TiO₂, talc, or combinations of these. Other refractory materials may also be used as the inorganic powder. In embodiments, the inorganic powder may be selected from the group consisting of alumina, silica, titania, zirconia, cordierite, mullite, spinel, forsterite, wollastonite, clinoenstatite, diopside, zircon, sapphirine, clay, SiC, Al₄C₃, ZrC, Si₃N₄, AlN, MgO, Mg(OH)₂, CaO, K₂O, Na₂O, KOH, NaOH, CaCO₃, B₂O₃, B(OH)₃, BN, B₄C, TiO₂, talc, and combinations of these.

As discussed, the inorganic powders may act as a rigid frame member, which can reduce the flowability softened hollow glass bodies when heated above the softening temperature of the hollow glass bodies. The inorganic powder may comprise a rigid frame material capable of maintaining its original particle shape at temperatures greater than the softening temperature of the hollow bodies. In embodiments, the inorganic powder may be able to maintain its original shape at temperatures greater than or equal to 500° C., greater than or equal to 1000° C., greater than 1200° C., or even greater than 1500° C. The inorganic powder may comprise a rigid frame material having a melt temperature greater than the softening temperature of the hollow glass bodies. In embodiments, the inorganic powder may comprise a rigid frame material having a melt temperature of greater than 1000° C., greater than 1200° C., or even greater than or equal to 1500° C. In embodiments, the inorganic powder may comprise a rigid frame material comprising one or more powders selected from the group consisting of alumina, silica, titania, zirconia, cordierite, mullite, spinel, forsterite, wollastonite, clinoenstatite, diopside, zircon, sapphirine, clay, SiC, Al₄C₃, ZrC, Si₃N₄, AlN, and combinations of these. Other refractory materials may be used as rigid frame members useful for the inorganic powders incorporated into the compositions disclosed herein. Incorporation of inorganic powders comprising rigid frame members can mitigate shrinkage caused by the flow of the glass of the hollow glass bodies when heated above the softening temperature of the glass.

As previously discussed, the inorganic powders can also act as a crystallizing agent, a reactive agent, or both, and may interact and/or react with the glass of the hollow glass bodies to form new crystal phase(s) at temperatures less than the softening temperatures of the hollow glass bodies by themselves. The formation of these new crystal phases at lesser temperatures can suppress shrinkage during the crystallization phase of firing. In particular, the new crystal phases formed may act as rigid bodies that may hinder or impede the flow of the remaining amorphous glass when heated above the softening temperature of the glass. Hindering the flow of the glass may reduce firing shrinkage of the green structures made from the compositions herein.

In embodiments, the inorganic powder may include at least one crystallizing agent or reactive agent capable of reacting with the glass of the hollow glass bodies to form new crystal phases at temperatures less than a softening temperature of the hollow glass bodies. In embodiments, the inorganic powder may include a crystallizing agent or reactive agent comprising one or more powders selected from the group consisting of MgO, Mg(OH)₂, CaO, K₂O, Na₂O, KOH, NaOH, CaCO₃, B₂O₃, B(OH)₃, BN, B₄C, TiO₂, talc, clay, forsterite, wollastonite, clinoenstatite, diopside, and combinations of these. In embodiments, the inorganic powder may include MgO, Mg(OH)₂, or a combination of these. In embodiments, the inorganic powder may include talc. In embodiments, the inorganic powder may include a clay. An exemplary clay may include 47 wt. % silica, 43.3 wt. % alumina, 1.6 wt. % titanium dioxide (TiO₂), 0.3 wt. % Fe₂O₃, and 0.1 wt. % MgO. Other types of clays are contemplated.

In embodiments, the inorganic powder may include a single inorganic powder that acts as one or more of a rigid frame material, a crystallization agent, a reactive agent, or combinations of these. In embodiments, the composition may include a plurality of different inorganic powders having different functionality with respect to providing rigid frame members, crystallization agents, or reactive agents.

The inorganic powder may have a median particle size that is less than or equal to the median particle size (D50) of the hollow glass bodies. In embodiments, the inorganic powder may have a median particle size that is less than 0.5 times the median particle size of the hollow glass bodies, or even less than or equal to 0.2 times the median particle size of the hollow glass bodies. In embodiments, the inorganic powder may have a median particle size that is from 0.01 to 0.5 times the median particle size of the hollow glass bodies. The median particle size of the inorganic powder can be in a range of from 10 nanometer (nm) to 100 micrometer (μm). The porosity of the porous structure prepared from the compositions disclosed herein may be tuned by changing the median or average particle size of the inorganic powder relative to the hollow glass bodies. Changing the median or average particle size of the inorganic powder may change the packing pattern of the inorganic powder and hollow glass bodies, which may change the porosity.

The inorganic powder may have a melt temperature greater than the softening temperature of the hollow glass bodies. The inorganic powder may have a melt temperature greater than or equal to the peak firing temperature at which the green structures made from the composition are fired. In embodiments, the inorganic powder may have a melt temperature of greater than or equal to 1000° C., greater than or equal to 1200° C., or even greater than or equal to 1500° C. In embodiments, the inorganic powder may have a melt temperature of from 1000° C. to 5000° C., from 1200° C. to 4000° C., or from 1500° C. to 3000° C.

The inorganic powder may be provided as a dry powder or may be provided in the form of a dispersion or suspension of the inorganic powder in a liquid solvent. In embodiments, the inorganic powder may be provided as a dispersion or suspension of the inorganic powder in a solvent which may further, optionally include a dispersant. The weight percentages and volume percentages discussed herein are based on the weight of the inorganic powder itself without the solvent and/or dispersant.

The composition may include an amount of the inorganic powder sufficient to reduce shrinkage of the green structures made therefrom during firing of the green structures but not so much that the amount of inorganic powder reduces the porosity of the porous structure to less than 50%. The amount of the inorganic powder in the composition may have an influence on the porosity of the resulting porous structure made therefrom. In embodiments, the composition may include less than 50 vol. %, less than or equal to 25 vol. %, or even less than or equal to 12.5 vol. % inorganic powders, where the volume percent (vol. %) is calculated as the true volume of the inorganic powder divided by the sum of the true volume of the inorganic powder and the true volume of the hollow glass bodies (including the internal volume of the hollow glass bodies). In embodiments, the composition may include from 1 vol. % to 50 vol. %, from 1 vol. % to 25 vol. %, from 1 vol. % to 12.5 vol. %, from 5 vol. % to 50 vol. %, from 5 vol. % to 25 vol. %, from 5 vol. % to 12.5 vol. %, from 12. % vol. % to 50 vol. %, or from 12.5 vol. % to 25 vol. % inorganic powder based on the total true volume of the hollow glass bodies (including internal volume) and the inorganic powder. The composition may include from 1 vol. % to 50 vol. % inorganic powder and from 50 vol. % to 99 vol. % hollow glass bodies, based on the total true volume of the hollow glass bodies (including internal volume) and the inorganic powder.

The compositions disclosed herein may include from 5 wt. % to 95 wt. % inorganic powder based on the combined weight of the inorganic powder and the hollow glass bodies. The composition may include from 5 wt. % to 90 wt. %, from 5 wt. % to 75 wt. %, from 5 wt. % to 60 wt. %, from 5 wt. % to 20 wt. %, from 10 wt. % to 95 wt. %, from 10 wt. % to 90 wt. %, from 10 wt. % to 75 wt. %, from 10 wt. % to 60 wt. %, from 10 wt. % to 20 wt. %, from 20 wt. % to 95 wt. %, from 20 wt. % to 90 wt. %, from 20 wt. % to 75 wt. %, from 20 wt. % to 60 wt. %, or from 60 wt. % to 75 wt. % inorganic powder, based on the combined weight of the inorganic powder and hollow glass bodies. In embodiments, the composition may include from 5 wt. % to 95 wt. % hollow glass bodies and from 5 wt. % to 95 wt. % inorganic powder based on the combined weight of the hollow glass bodies and inorganic powders. In embodiments, the composition may include from 5 wt. % to 95 wt. %, 5 wt. % to 90 wt. %, from 5 wt. % to 75 wt. %, from 5 wt. % to 60 wt. %, from 5 wt. % to 20 wt. %, from 10 wt. % to 95 wt. %, from 10 wt. % to 90 wt. %, from 10 wt. % to 75 wt. %, from 10 wt. % to 60 wt. %, from 10 wt. % to 20 wt. %, from 20 wt. % to 95 wt. %, from 20 wt. % to 90 wt. %, from 20 wt. % to 75 wt. %, from 20 wt. % to 60 wt. %, or from 60 wt. % to 75 wt. % inorganic powder based on the total weight of the composition, including the hollow glass bodies, inorganic powder, water, binder, and additives.

The compositions disclosed herein may include one or more binders. A binder is used to bond particles together to form the green structure that can hold a honeycomb shape until the green structure can be fired. Binder can be any kind of cellulose or cellulose derivatives. The binder can also be a polymer binder, such as but not limited to polyvinyl alcohol (PVA) polymers. In embodiments, the compositions may include a binder that comprises cellulose, cellulose derivatives, polymer binders, or combinations thereof. In embodiments, the binder may include methylcellulose. In embodiments, the composition may include from 5 wt. % to 20 wt. % binder based on the combined weight of the hollow bodies and the inorganic powder.

In embodiments, the compositions may include one or more additives, such as a slip agent and/or lubricant, such as oil or sodium stearate. In embodiments, the additives may act as rheology modifiers to make the batch easier to extrude, increase the extrusion rate, and improve the quality of the honey comb-shaped porous structure. In embodiments, the additives may include sintering aids, such as but not limited to sodium stearate or other sintering aids. In embodiments, the additives may include a pore former, such as an organic pore former, such as a starch (e.g., corn starch, pea starch, etc.). The additives can be sodium stearate, oil, graphite, starch, other additives, or combinations of these. In embodiments, the composition may comprise one or more additives selected from the group consisting of sodium stearate, oil, graphite, starch, and combinations of these. The compositions may include from greater than 0 wt. % to 5 wt. % additives, such as from 0.1 wt. % to 5 wt. % additives based on the total weight of the composition. In embodiments, the composition may not include one or more additives. In embodiments, the composition may not include sodium stearate or other sintering aids. In embodiments, the composition may not include a pore former, such as starch.

The compositions may include water. The amount of water in the composition may be sufficient to enable the composition to be extruded or otherwise shaped or formed into the green structure but not so much that the green structure is unable to maintain its shape after formation. The compositions may include from 25 wt. % to 100 wt. % or from 30 wt. % to 70 wt. % water based on the combined weight of the hollow bodies and the inorganic powder.

In embodiments, the batch density (e.g., “wet batch” density) of the composition may be less than or equal to 1.5 g/cm³, such as less than or equal to 1.0 g/cm³, less than or equal to 0.5 g/cm³, or even less than or equal to 0.3 g/cm³. The batch density of the composition may be greater than or equal to 0.1 g/cm³. In embodiments, the green structures and batch material comprising the composition may float in water (i.e. specific gravity less than 1, compared to water), while finished porous structures, after firing and/or breaching of the hollow glass bodies, may sink in water.

The compositions of the present disclosure comprising the hollow glass bodies and the inorganic powder may have a peak firing temperature less than the peak firing temperature of compositions having only the hollow glass bodies without the inorganic powder. The compositions of the present disclosure may have peak firing temperatures of less than or equal to 1400° C., less than or equal 1200° C., less than or equal to 1000° C., less than or equal to 800° C., or even less than or equal to 600° C. The compositions disclosed herein may have a peak firing temperature of from 500° C. to 1400° C., from 500° C. to 1200° C., from 500° C. to 1000° C., from 500° C. to 970° C., from 500° C. to 800° C., from 500° C. to 600° C., from 600° C. to 1400° C., from 600° C. to 1200° C., from 600° C. to 1000° C., from 600° C. to 970° C., from 600° C. to 800° C., from 800° C. to 1000° C., from 800° C. to 970° C., or from 970° C. to 1000° C. In embodiments, the composition may include Na₂O, K₂O, B₂O₃, or combinations of these as the inorganic powder, and the composition may have a peak firing temperature of from 500° C. to 800° C.

The present disclosure may also include methods of making the porous structures disclosed herein. A method for making a porous structure disclosed herein may include preparing the composition comprising hollow glass bodies, an inorganic powder, a binder, and water; forming the green structure from the composition; and firing the green structure, wherein firing the green structure bonds the hollow glass bodies and inorganic powder together and breaches at least a portion of the hollow glass bodies to form the porous structure having a size and shape that is within 10%, within 5%, within 3%, within 2%, or even within 1% of a size and shape of the green structure before firing.

Preparing the composition may include combining the hollow glass bodies, inorganic powder, water, and binder. One or more additives may also be combined into the composition. The constituents of the composition may be combined and mixed according to known methods. The hollow glass bodies, inorganic powder, binder, water, and additives may have any of the features, properties, or amounts previously described herein. The average pore size of the porous structure may be modified by changing the make-up of the composition. In particular, methods disclosed herein may include tuning an average pore size of the porous structure by changing a proportion of the inorganic powder to the hollow glass bodies in the composition. The average pore size may also be tuned by modifying the peak firing temperature, the hold/dwell time at the peak firing temperature, the temperature ramping rate during heating or combinations of these. Increasing the peak firing temperature, increasing the hold/dwell time at the peak firing temperature, and decreasing the temperature ramping rate during heating may all increase the average pore size to the extent the whole structure is not completely melted. In embodiments, the methods may include modifying a porosity of the porous structure by changing an amount of the inorganic powder in the composition.

After preparation of the composition, the methods disclosed herein may include forming the green structure comprising the composition. In embodiments, the composition may be formed into a green structure having a honeycomb shape having a plurality of elongate channels extending through the green structure (e.g., elongate channels 212 as shown in FIG. 2). Forming the green structure may include extrusion, molding, tape-casting, rolling, calendaring, 3D printing, other forming process, or combinations of these. Extruding the green structures may be particularly efficient for forming through-channels (e.g., elongate channels 212 as shown in FIG. 2) in porous structures such as the honeycomb-shaped porous structure of FIG. 1, or other regular features in the respective green structures. However, in other contemplated embodiments, such green structures may be molded, tape-cast, or otherwise shaped or processed, which may better or alternatively preserve integrity of the hollow glass bodies. In still other contemplated embodiments, structures with shapes far different from those of porous structures 112, 210, 310, may be extruded or otherwise formed.

In embodiments, the composition may be extruded to form the green structures from the composition. Extrusion may be accomplished using a twin-screw extruder or other suitable extrusion machine. The composition comprising the hollow glass bodies and inorganic powder may be extruded at a rate and pressure to preserve integrity of most (e.g., more than 50%, more than 75%, more than 90%) of the hollow glass bodies. With that said, in other contemplated embodiments, extrusion rate and pressure may preserve integrity of many of the hollow glass bodies, but not most, such as less than 50%, but at least 25%, or at least 20%. Preserving integrity of the hollow glass bodies may allow the hollow glass bodies to occupy relatively large volumes of space within the green structures with voids between the hollow glass bodies and within the hollow glass bodies (i.e., the internal volume of the hollow glass bodies). The extrusion rates and pressures may vary depending upon the size of the hollow glass bodies, the glass of the hollow glass bodies, and the extruding device. In some embodiments, extrusion pressures may be in the range of less than 2500 psi, such as less than 2000 psi, and/or at least 500 psi.

Following forming of the green structures from the composition, the methods may include firing the green bodies to a peak firing temperature. Conditions and handling of the green structures during the heating is such that adjoining hollow glass bodies may physically interact with one another, such as directly bond to one another (e.g., sinter, weld, melt-into), but without fully losing their individual structures. Put another way, in such embodiments, the conditions and handling during firing are such that the hollow glass bodies do not fully liquefy and/or completely lose structure, and instead become bonded to one another such that, in the aggregate, the resulting structure is cohesive and rigid.

Additionally, in embodiments, the conditions and handling of the green structures during the heating may be such that many of the hollow glass bodies (e.g., most, >90%, >95%, >99%) breach or break, such as by rupture from internal gas expansion and/or by devitrification or otherwise. The green structures may be heated to a point that the hollow glass bodies lose integrity and the glass of the hollow glass bodies shatters or is otherwise breached. In other contemplated embodiments, the hollow glass bodies may be breached by microwaves, sound, or other phenomena. Breaching the hollow glass bodies may be counterintuitive to those in industry, where hollow glass bodies may be relied upon to provide buoyancy and/or prevent inflow of materials into voids within the hollow glass bodies or through the hollow glass bodies. However, Applicant has found that by breaching the hollow glass bodies contained in green bodies, as disclosed herein, voids of the hollow glass bodies may be maintained and/or even enlarged and joined to one another to create a porous structure.

In embodiments, the green structures may be heated, such as by firing the green structures in a furnace, by laser heating the green structures, or other heating methods. The heating may burn out, char, chemically transform, or otherwise influence the binder. In embodiments, the methods may include heating the green structures to at least to a softening temperature of glass of the hollow glass bodies. But, the hollow glass bodies are not overheated, such as being heated well above a liquidus temperature of the glass, at which temperatures the hollow glass bodies may fully lose cohesion or structure. The methods may include heating the green structures to a peak firing temperature that is at least greater than or equal to a softening temperature of the glass and less than a liquidus temperature of the glass. Depending upon the glass composition and materials in the composition used to make the green structures, the methods may include heating the green bodies to a peak firing temperature of at least 400° C., at least 500° C., at least 600° C., at least 800° C., and less than or equal to 1400° C., less than or equal to 1200° C., less than or equal to 1000° C., less than or equal to 970° C., even less than or equal to 800° C. In embodiments, the methods may include heating or firing the green structure to a peak firing temperature of less than or equal to 1400° C., such as from 500° C. to 1400° C., from 500° C. to 1200° C., from 500° C. to 1000° C., from 500° C. to 800° C., from 500° C. to 600° C., from 600° C. to 1400° C., from 600° C. to 1200° C., from 600° C. to 1000° C., from 600° C. to 800° C., from 800° C. to 1400° C., from 800° C. to 1200° C., or from 800° C. to 1000° C. In embodiment, the composition may include Na₂O, K₂O, B₂O₃, or combinations of these as the inorganic powder, and the firing temperature may be reduced to as low as 500° C., such as from 500° C. to 800° C.

In embodiments, firing the green structures may include conducting a firing process to systematically heat the green structure to the peak firing temperature. In embodiments, the firing process may include heating the green structure to the peak firing temperature at a generally constant temperature ramping rate of from 50° C. per hour to 300° C. per hour, holding the green structures at the peak firing temperature for a time of from 1 hour to 10 hours, and then cooling the green structures back to ambient temperatures.

In some embodiments, firing the green structures may include debinding the composition of the green structures. Debinding the green structures may include heating the green structures from ambient temperature to a first temperature(s) (e.g., fixed temperature and/or temperatures in a limited range) at a generally constant ramping rate of from 50° C. per hour to about 300° C. per hour. The first temperature may be in a debind temperature range for the composition. The debind temperature range may be from 200° C. to 400° C. or from 300° C. to 400° C. The first temperature is less than a lower crystallization temperature of the glass of the hollow glass bodies, which is the temperature at which crystallization of the glass begins. The green bodies may be held at the first temperature for a first dwell time, which may be at least 1 minute, such as from 1 minute to 10 hours or from 1 hour to 10 hours. Alternatively or additionally, in embodiments, at the first temperature, the temperature ramping rate may be reduced to a temperature ramping rate of less than 50° C. per hour, less than or equal to 20° C. per hour, less than 10° C. per hour, or even less than 5° C. per hour. The temperature ramping rate may be maintained at the lower temperature ramping rate until the upper debind temperature of around 400° C. is reached, at which point the temperature ramping rate may be returned to the first ramping rate of from 50° C. per hour to 300° C. per hour. In embodiments, the firing process for firing the green structures to produce the porous structure may not include debinding the composition of the green structure.

In embodiments, the temperature may be increased to a second temperature(s). The second temperature may be in a crystallization range of the glass, such as a temperature greater than the lower crystallization temperature and less than the upper crystallization temperature of the glass of the hollow glass bodies. The second temperature may be greater than 400° C., such as from 600° C. to 1200° C. or from 600° C. to 800° C. The green structures may be held at the second temperature for a second dwell time of at least 1 minute, such as from 1 hour to 10 hours. In embodiments, during the firing process, the temperature is increased from the second temperature(s) to a third temperature(s) with a third dwell time, such as where the second temperature is above 400° C. and below a softening point of glass of the hollow glass bodies and the third temperature is above the softening point of the glass of the hollow glass bodies. The third temperature may be the peak firing temperature. The third dwell time may be at least 1 minute, such as from 1 hour to 10 hours.

In embodiments of the methods disclosed herein, firing the green structures may include heating the green structure to a de-bind temperature of from 200° C. to 400° C. and maintaining the green structure at the de-bind temperature for a de-bind dwell time. The de-bind dwell time may be from 1 hour to 10 hours. In embodiments, firing the green structures may not include a de-bind dwell time and the temperature of the green structures may be ramped continuously through the de-bind temperature range. Firing the green structures may further include ramping the temperature of the green structure to the lower crystallization temperature of the hollow glass bodies at a first ramping rate of from greater than 100° C. per hour to 250° C. per hour. At the lower crystallization temperature of the hollow glass bodies, firing may include slowing the temperature ramp rate to a second ramping rate of less than 100° C. per hour or holding the temperature of the green structures at a temperature between the lower crystallization temperature of the glass and the upper crystallization temperature of the glass for a time period of from 1 hour to 10 hours. Slowing the temperature ramping rate in the crystallization temperature range or holding the green structure at a temperature in the crystallization temperature range may reduce shrinkage of the porous structure compared to the green structure, as will be described in further detail herein. Firing the green structures may further include ramping the temperature of the green structures to the peak firing temperature of the green structure and maintaining the green structure at the peak firing temperature for a period of from 1 hour to 10 hours. The firing process converts the green structures to the porous structures disclosed herein.

The present compositions can be fired with parts stacking. In embodiments, the inorganic powder of the composition can act as a rigid frame components and/or a crystallization agent reactive with the glass of the hollow glass bodies, both of which can prevent stacking parts from sticking during firing step. The methods disclosed herein may further include stacking a plurality of green structures formed from the composition and then firing the stacks of green structures to produce the porous structures according to any of the firing processes disclosed herein.

Following firing the green structures to the peak firing temperature and holding the green structures at the peak firing temperature for a period of time to produce the porous structures, the porous structures may be cooled back to ambient temperature. The methods disclosed herein for making the porous structures may comprise cooling the porous structure back to ambient temperature following firing at the peak firing temperature. In embodiments, the methods may include cooling the porous structures to a temperature that is at least 100° C. less than the temperatures to which the green structures were heated during firing (i.e., peak firing temperature). In embodiments, the methods may include cooling the porous structures to a temperature less than 100° C. or even less than 50° C., such as a temperature of from 20° C. to 100° C., or from 20° C. to 50° C. During the cooling, the adjoining hollow glass bodies, which may be less spherical at this point, are and/or remain physically bonded to one another, such as directly or indirectly bonded. Indirect boding may refer to adjacent hollow glass bodies being bonded to each other through an intermediate bonding agent, such as particles of the inorganic powder or residue of the binder added to the composition.

In embodiments, cooling the porous structures may include dwelling the porous structures at temperatures greater than the ambient temperatures but less than the firing temperatures. In embodiments, cooling the porous structures may include dwelling the porous structures at an annealing temperature of the glass of the hollow glass bodies. Dwelling may occur at incremental steps, in some embodiments, or may be in the form of very gradual temperature declines within certain temperature ranges in other embodiments, both of which may allow for formation of crystals in the materials of the hollow glass bodies and/or may facilitate relaxing of residual stresses by annealing.

In embodiments, the methods disclosed herein for making the porous structures may include modifying the median pore size of the porous structure may changing the average and/or median particle size of the inorganic powder, the content of inorganic powder, or both included in the composition. In embodiments, the methods may include changing the porosity of the porous structures by changing the concentration of the inorganic powder, the content of the inorganic powder, or both included in the composition.

The porous structure produced from the composition, green structures, and firing process may comprise the hollow glass bodies and inorganic powder that are sintered together. At least a portion of the hollow glass bodies in the porous structure are breached. In embodiments, the porous structure may have greater than or equal to 50%, greater than or equal to 70%, greater than or equal to 80%, or even greater than or equal to 90% and less than or equal to 100% of the hollow glass bodies are breached. The voids defined within the individual breached hollow glass bodies may open into one another to form cavities that extend through the porous structure and to outer surfaces thereof.

The porous structures produced from the compositions disclosed herein may comprise primarily the constituents from the glass of the hollow glass bodies and the inorganic powder. In embodiments, the porous structures may comprise greater than or equal to 5 wt. %, greater than or equal to 10 wt. %, greater than or equal to 20 wt. %, or greater than or equal to 30 wt. % inorganic powder based on the total weight of the porous structure. The porous structures may comprise less than or equal to 95 wt. %, less than or equal to 90 wt. %, less than or equal to 75 wt. %, less than or equal to 65 wt. %, or even less than or equal to 60 wt. % inorganic powder based on the total weight of the porous structure. The porous structures may comprise from 5 wt. % to 95 wt. %, from 10 wt. % to 75 wt. %, from 10 wt. % to 65 wt. %, from 10 wt. % to 60 wt. %, from 10 wt. % to 30 wt. %, from 20 wt. % to 75 wt. %, from 20 wt. % to 65 wt. %, from 20 wt. % to 60 wt. %, from 30 wt. % to 75 wt. %, from 30 wt. % to 65 wt. %, from 30 wt. % to 60 wt. %, or from 40 wt. % to 60 wt. % inorganic powder based on the total weight of the porous structure.

In embodiments, the porous structures may comprise greater than or equal to 5 wt. % silica glass, such as greater than or equal to 25 wt. %, greater than or equal to 40 wt. %, greater than or equal to 50 wt. % silica glass, or even greater than or equal to 60 wt. % silica glass based on the total weight of the porous structure. The porous structures may comprise less than or equal to 95 wt. % silica glass, such as less than or equal to 90 wt. %, less than or equal to 80 wt. %, less than or equal to 70 wt. %, or even less than or equal to 60 wt. % silica glass based on the total weight of the porous structure. The porous structures may comprise from 5 wt. % to 95 wt. %, from 25 wt. % to 90 wt. %, from 25 wt. % to 80 wt. %, from 25 wt. % to 70 wt. %, from 25 wt. % to 60 wt. %, from 25 wt. % to 50 wt. %, from 25 wt. % to 40 wt. %, from 40 wt. % to 90 wt. %, from 40 wt. % to 80 wt. %, from 40 wt. % to 70 wt. %, from 40 wt. % to 60 wt. %, from 50 wt. % to 90 wt. %, from 50 wt. % to 80 wt. %, from 50 wt. % to 70 wt. %, from 60 wt. % to 90 wt. %, from 60 wt. % to 80 wt. %, or from 60 wt. % to 70 wt. % silica glass based on the total weight of the porous structure. The porous structures may also include small amounts of binder or compounds resulting from firing the binder and other additives.

At least some of the glass of the hollow glass bodies may be devitrified such that the glass comprises one or more crystal phases. The crystal phases of the glass may include constituents from the inorganic powder, particularly when the inorganic powder is a crystallizing agent. Gradually heating and dwelling the green structures, as disclosed herein, may facilitate crystal growth, which may toughen the resulting porous structures. While composition of the green structures may include amorphous hollow glass bodies, the porous structures after firing may be glass-ceramics with crystallinity greater than or equal to 45% by weight (wt. %), such as greater than or equal to 50 wt. %, greater than or equal to 60 wt. %, greater than or equal to 70 wt. %, greater than or equal to 80 wt. %, greater than or equal to 90 wt. %, or even greater than or equal to 95 wt. % crystallinity based on the total weight of the porous structure. In embodiments, the porous structure may comprise less than 55 wt. %, less than 50 wt. %, or even less than 36 wt. % amorphous phase glass based on the total weight of glass in the porous structure. In embodiments, the porous structure may include from 1 wt % to 55 wt. %, from 5 wt. % to 50 wt. %, from 5 wt. % to 36 wt. %, from 10 wt. % to 55 wt. %, from 10 wt. % to 50 wt. %, or from 10 wt. % to 36 wt. % amorphous-phase glass based on the total weight of the porous structure.

The porous structures may have a high porosity of greater than or equal to 50% or greater than or equal to 70%, such as from 50% to 85% or from 70% to 85%, as determined by mercury intrusion porosimetry as discussed herein. The porosity of the porous structures made from a composition comprising both the hollow glass bodies and the inorganic powder may have a porosity greater than an equivalent porous structure made from the hollow glass bodies only and without the inorganic powder. The porosity may be modified by changing the content of the inorganic powder in the composition. As previously discussed, the composition for making the porous structure may have less than or equal to 50 vol. %, less than or equal to 25 vol. %, or even less than or equal to 12.5 vol. % inorganic powder in order to provide a porosity of greater than 50%, or even greater than 70%. The porous structures may have a total volume, within outer surfaces thereof (see, e.g., outer surface having the openings on outer surface 214 of FIG. 2), of at least 1 cubic centimeter (cm³), such as at least 2 cm³, such as at least 10 cm³, such as at least 50 cm³, and/or no more than 2000 cm³, such as no more than 1000 cm³. In embodiments, the pore volume may be much larger than 2000 cm³, such as for large frontal area filters. Internal walls formed between pores within the porous structures may be particularly thin, such as less than 1 millimeters (mm) in thickness, such as less than 500 micrometers (μm), less than 100 μm, less than 50 μm, less than 10 μm, or even less than 5 μm.

The porous structures of the present disclosure may have a median pore size of from 1 μm to 50 μm, from 1 μm to 20 μm, from 1 μm to 16 μm, from 8 μm to 50 μm, from 8 μm to 20 μm, from 8 μm to 16 μm, from 12 μm to 50 μm, from 12 μm to 20 μm, or from 12 μm to 16 μm. The median pore size may refer to a d₅₀ value, which corresponds to a 50% pore size of a porous structure, as measured by ASTM standard with mercury intrusion. The median pore size can be tunable by adjusting the packing pattern of hollow glass bodies and particles of the inorganic powder. The combination of the hollow glass bodies with an inorganic powder may enable a broader range of pore size distribution for the porous structures herein compared to porous structures made with only the hollow glass bodies and no inorganic powder. The median pore size can be tuned in the range of from 1 μm to 50 μm.

The porous structure may have a pore size distribution characterized by a D-factor. The D-factor of the porous structure is defined to be equal to the quotient (d₅₀−d₁₀)/d₅₀. The d₅₀ value refers to a median pore diameter of the porous structure at which 50% by volume of the open porosity of the porous structure has been intruded by mercury during a porosimetry measurement made according the methods disclosed herein. The quantity d₁₀, as used herein, is the pore diameter at which 10% of the pore volume is comprised of pores with diameters smaller than the value of d₁₀. The d₁₀ value of the porous structure is equal to the pore diameter at which 90% by volume of the open porosity of the porous structure has been intruded by mercury during a porosimetry measurement. In embodiments, the porous structures including the hollow glass bodies and inorganic powder may have a pore size distribution (d₅₀-d₁₀)/d₅₀ of less than 0.5, such as less than or equal to 0.4, less than or equal to 0.3, less than or equal to 0.2, less than or equal to 0.1, or less than or equal to 0.06. In embodiments, the porous structure may have a D-factor (i.e., (d₅₀−d₁₀)/d₅₀) of less than or equal to 0.5 or even less than or equal to 0.3.

As previously discussed, the composition comprising the hollow glass bodies and the inorganic powder may reduce the shrinkage of the porous structure compared to the green structure prior to firing. The porous structures made from the composition comprising the hollow glass bodies and inorganic powder may exhibit less than or equal to 15%, less than or equal to 10%, less than or equal to 8%, less than or equal to 5%, less than or equal to 2%, or even less than or equal to 1% shrinkage compared to a green structure comprising the composition prior to firing. In embodiments, the porous structure may have a size and shape within 15%, within 10%, within 8%, within 5%, within 2%, or even within 1% of a size and shape of a green structure comprising the composition prior to firing. The reduced shrinkage may also enable improved control of the fired ware geometry and may decrease substrate defects resulting from shrinkage, among other features.

The porous structures made from the compositions comprising the hollow glass bodies and the inorganic powders may have a greater mechanical strength compared to porous structures made with hollow glass bodies without the inorganic powders. Additionally, the lesser weight of the hollow bodies compared to conventional materials may reduce the effects of gravity on the walls of the porous structures, thus, reducing stress on the walls of the porous structures. The greater mechanical strength of the porous structures of the present disclosure can facilitate thinner web thicknesses and can enable reduced cell density of honeycomb shaped porous structures compared the honeycomb shaped porous structures made from compositions comprising hollow glass bodies with no inorganic powders. In some applications, the reduced cell density (i.e., fewer cells each with greater cross-sectional area) can reduce pressure drop through the honeycomb shaped porous structures and/or reduce backpressure. The greater mechanical strength may also make parts handling easier to reduce breakage of the porous structures during manufacturing. In embodiments, the porous structures disclosed herein may have a modulus of rupture of greater than 0.3 megapascals (MPa), such as greater than or equal than 0.5 MPa, or even greater than or equal to 0.7 MPa as determined according to 4 point bending testing as described herein. In embodiments, the porous structures may have a modulus of rupture of from 0.9 MPa to 3 MPa, such as 0.9 MPa to 2 MPa, from 0.7 MPa to 3 MPa, or from 0.7 MPa to 2 MPa, as determined according to the methods disclosed herein.

In embodiments, the porous structures may have a honeycomb shape comprising a plurality of elongate channels extending through at least a portion of the porous structure, as previously described in relation to FIG. 1. The porous structures may have a cell density (i.e., number of elongate channels per unit cross-sectional area) of greater than or equal to 50 cells per square inch (cpsi), such as greater than or equal to 100 cpsi, greater than or equal to 200 cpsi, or greater than or equal to 300 cpsi. The porous structures may have a cell density of less than or equal to 400 cpsi.

Each of the elongate channels may be separated by cell walls. As previously discussed, the greater strength of the porous structures made with the hollow glass bodies and inorganic powders may enable the web thickness (i.e., thickness of the walls between elongate channels of a honeycomb shaped porous structure) of the porous structure to be reduced. The porous structures disclosed herein may have a web thickness of less than or equal to 10 mils (i.e. thousandths of an inch), such as no more than 8 mils, such as no more than 7 mils, such as no more than 6 mils, such as no more than 5 mils. The porous structures disclosed herein may have a web thickness of from 2 mils to 10 mils, from 2 mils to 8 mils, from 2 mils to 7 mils, from 2 mils to 6 mils, or from 2 mils to 5 mils. In embodiments, the porous structures may have a combination of cell density and web thickness (i.e., noted as: (cell density in cpsi)/(web thickness in mils)) of about 200/8. In other embodiments, the porous structures may have combinations of cell density and web thickness of 400/7, 400/6, 400/5, 400/4, 400/3, 400/2, 300/7, 300/6, 300/5, 300/4, 300/3, 300/2, 200/7, 200/6, 200/5, 200/4, 100/8, 100/7, 100/6, 100/5, 50/8, 50/7, or 50/6, where left of the “/” is the cell density in cpsi and to the right of the “/” is the web thickness in mils.

In embodiments, the porous structures may have a cylindrical geometry and may have a diameter of greater than or equal to 2 inches, greater than or equal to 4 inches, greater than or equal to 6 inches, greater than or equal to 8 inches, greater than or equal to 12 inches, or greater than or equal to 24 inches. The diameter of the porous structure may be less than or equal to 64 inches or less than or equal to 36 inches. In embodiments, the porous structure may have a generally square, rectangular, or other polygonal geometry in cross-section, with sides of greater than or equal to 2 inches, greater than or equal to 4 inches, greater than or equal to 6 inches, greater than or equal to 8 inches, greater than or equal to 12 inches, or greater than or equal to 24 inches. The sides of the porous structure may be less than or equal to 64 inches or less than or equal to 36 inches. Other contemplated embodiments have other sizes or shapes. Such geometries may facilitate low pressure drop, high dust loading, and high filtration efficiency.

Additionally or alternatively, the shrinkage of porous structures produced from hollow glass bodies can be reduced by modifying the firing process and controlling the temperature ramping rate during the crystallization phase of the firing process. Green structures made from hollow glass bodies without the added inorganic powders typically shrink by as much 15% in each of the three Cartesian coordinates during the firing process. When the temperature of the green structures reaches the softening temperature of the glass of the hollow glass bodies, the green structures start to shrink and continues to shrink until the temperature of the green structures reaches the set peak firing temperature. During the cool-down process, the green structures do not further shrink. Referring now to FIG. 15, the shrinkage of a piece of honeycomb-shaped green structure made with hollow glass bodies, binder, oil, and water is graphically depicted. As shown in FIG. 15, significant shrinkage of the green structure begins at a temperature just below 700° C.

Not intending to be bound by any particular theory, it is believed that shrinkage of the green structures is an outcome of two competing process. (1) Flow of the viscous phase material of the composition comprising the green structure; and (2) crystallization. Regarding flow of the viscous phase materials, once the temperature of the green structure reaches the softening temperature of the hollow glass bodies, the glass of the hollow glass bodies may transition to a viscous phase, the flow of which viscous phase may contribute to shrinkage. Generally speaking, the viscosity of the glass decreases with increasing temperature, causing the materials in the composition to flow faster at greater temperatures. Thus, as the temperature of the green structure increases, the impact of flow of the glass articles may be greater. Regarding crystallization, before firing, the glass of the hollow glass bodies is 100% amorphous. During the firing process, crystals are formed in the glass of the hollow glass bodies. These crystal structures hinder the viscous flow of the viscous phase, thus reducing the shrinkage of the green structures. Thus, shrinkage may be reduced by increasing crystallization, which may decrease viscous flow of the glass of the hollow glass bodies during firing.

The methods of the present disclosure further include methods of firing green structures comprising hollow glass bodies to reduce shrinkage. The firing methods disclosed herein include reducing the temperature ramping rate of the green structures in a crystallization phase of the firing process to a temperature ramping rate of less than 100° C. per hour. Additionally or alternatively, the firing methods may further include holding the green structures at a temperature in the crystallization temperature range for a dwell period. Slowing the temperature ramping rate and/or holding the green structures at a temperature within the crystallization temperature range of the glass may reduce shrinkage by increasing crystallization of the glass, which may hinder the viscous flow of softened glass at temperatures above the softening temperature.

The firing methods disclosed herein may reduce the shrinkage of the porous structures to less than or equal to 10% relative to the green structures before firing. The firing methods may further enable the cell density (cells per square inch) of honeycomb-shaped porous structures to be reduced and the channel size increased. Reducing the shrinkage and cell density and increasing the channel size of the cells can result in significant cost savings for producing honeycomb-shaped porous structures for filter devices. For example, reducing shrinkage from 15% to 10% can reduce material usage for producing the porous structures by 12.5%. Additionally, reducing the shrinkage from 15% to 10% may increase the line speed of the production process by 4.5%, thereby increasing throughput from the process.

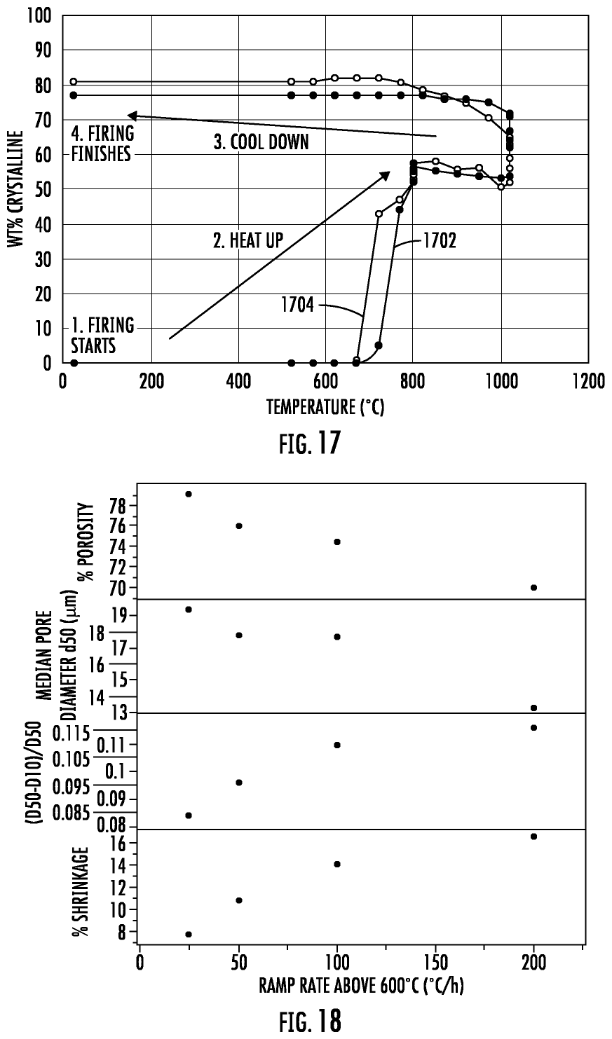

The crystallization reaction typically starts to take place once the green structure has reached a temperature greater than or equal to 600° C. Slowing the temperature ramp-up rate in the crystallization temperature range, such as a range of from 600° C. to 800° C., may provide more time for the crystallization reaction to take place (e.g., more time for the material to reach its equilibrium state). With more crystals, the flow of the viscous phase is slower, thus reducing the shrinkage. Referring now to FIG. 17, the high temperature XRD results as a function of temperature during firing of a green structures comprising H60 hollow glass microspheres at a constant temperature ramping rate of 150° C. per hour (ref. no. 1702) and a constant temperature ramping rate of 25° C. per hour (ref. no. 1704). Specifically in the temperature range between 670° C. and 770° C. during the heat-up process, the green structure being fired with the slower ramp-up of 25° C. per hour (1704) has a significantly higher crystalline percentage compared to the green structure fired with the faster temperature ramp-up rate of 150° C. per hour (1702).

A method for preparing a porous structure may include forming a composition to produce a green structure, wherein the composition comprises at least hollow glass bodies, a binder, and water. The composition may also include an inorganic powder. In embodiments, the composition does not include the inorganic powder. The composition may have any of features, constituents, or properties previously discussed herein for the composition. The method may further include firing the green structure to produce the porous structure. Firing may include heating the green structure to the de-bind temperature of from 200° C. to 400° C., maintaining the green structure at the de-bind temperature for a period of from 1 hour to 10 hours, ramping the temperature of the green structure to a first temperature less than a lower crystallization temperature of the hollow glass bodies at a first ramping rate of from greater than or equal to 50° C. per hour to 300° C. per hour, such as from 100° C. per hour to 250° C. per hour, and at the first temperature, slowing the temperature ramp rate to a second ramping rate of less than 100° C. per hour wherein slowing the ramping rate at the first temperature provides greater time for crystallization and reduces shrinkage of the porous structure compared to the green structure. The second ramping rate is less than the first ramping rate. The first temperature may be referred to as a crystallization zone lower temperature, which is the temperature at which the ramping rate is reduced to increase the amount of time the green structures spend exposed to temperatures in a range to promotes crystallization.

The method may further include ramping the green structure to the peak firing temperature of the green structure and maintaining the green structure at the peak firing temperature for a period of from 1 hour to 10 hours. In embodiments, the temperature of the green structure may be ramped at the second ramping rate until the temperature of the green structure reaches a crystallization zone upper temperature. As used herein, the term “crystallization zone upper temperature” for a composition, such as a glass, may refer to a temperature at which enough crystallization of constituents of the composition has occurred to reduce or prevent shrinkage of a green structure during the remaining stages of firing the green structure. In embodiments, the crystallization zone upper temperature for the glass of the hollow glass bodies may be a temperature at which an amount of the glass that has crystallized is in a range of from 40% by weight to 60% by weight based on the total weight of the glass in the green structure. The crystallization zone upper temperature may be less than or equal to the upper crystallization temperature for the composition. Above the crystallization zone upper temperature, the constituents of the composition may continue to crystallize, but further crystallization of these constituents do little to further effect shrinkage of the green structure. In embodiments, the temperature of the green structure may be ramped at the second ramping rate for a slow ramp period of from 1 to 10 hours. At the end of the slow ramp period, such as when the temperature of the green structure exceeds the crystallization zone upper temperature and/or when the degree of crystallization is sufficient to slow down viscous flow, the temperature of the green structure may be ramped at a greater ramping rate, such as a temperature ramping rate of greater than or equal to 100° C./hr until the temperature reaches the peak firing temperature.

In embodiments, the methods disclosed herein may include maintaining the temperature ramp rate at the second ramping rate until the temperature of the green structure reaches the peak firing temperature. In embodiments, ramping the green structure to the peak firing temperature of the green structure may include ramping the temperature of the green structure at the second ramping rate until the temperature of the green structure reaches a second temperature, wherein the second temperature may be greater than or equal to an upper crystallization temperature of the glass; maintaining the green structure at the second temperature for a dwell duration of from 1 hour to 10 hours; and ramping the temperature of the green structure up to the peak firing temperature at a third ramping rate greater than the second ramping rate, such as greater than or equal to 50° C. per hour or from 50° C. per hour to 300° C. per hour or from 100° C. per hour to 250° C. per hour. In embodiments, ramping the green structure to the peak firing temperature of the green structure may include ramping the temperature of the green structure at the second ramping rate until the temperature of the green structure reaches a second temperature, wherein the second temperature may be greater than or equal to an upper crystallization temperature of the glass; and ramping the temperature of the green structure from the second temperature up to the peak firing temperature at a third ramping rate greater than the second ramping rate, such as greater than or equal to 50° C. per hour, from 50° C. per hour to 300° C. per hour, or from 100° C. per hour to 250° C. per hour.

In embodiments, the methods disclosed herein may include cooling the porous structure after maintaining the green structure at the peak firing temperature. In embodiments, cooling the porous structure may include ramping the temperature down to ambient temperature over a period of from 1 hour to 10 hours. In embodiments, cooling the porous structure may include cooling the porous structure to an annealing temperature of a glass of the hollow glass bodies, holding at the annealing temperature for an annealing time of from 1 hour to 10 hours, and cooling the porous structure from the annealing temperature to ambient temperature. The porous structure fired with a second ramping rate of less than −100° C. per hour, or from −25° C. per hour to −100° C. per hour, in the crystallization temperature range (e.g, temperature range between the lower crystallization temperature and upper temperature range) may have a shrinkage of less than 15% or even less than or equal to 10% compared to the green structures prior to firing.

The porous structures disclosed herein may be used as filters for removing particulates from air or other gases. The filters may include the porous structures having any of the features, compositions, and/or properties disclosed herein for the porous structures. In embodiments, a filter may include the porous structure disclosed herein and a coating supported by the porous structure. The coating may be configured or selected to influence, block, and/or attract target particulate. The filter may further include a housing that at least in part surrounds the porous structure or the porous structure and the coating.

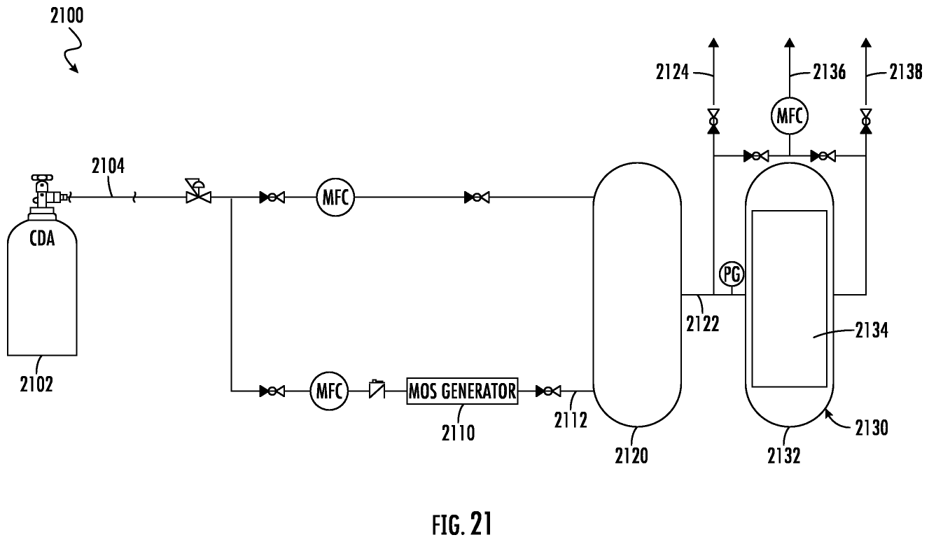

The porous structures of the present disclosure may also be used in a carbon dioxide (CO₂) capture process. In particular, any of the porous structures disclosed herein may be incorporated into an adsorption/desorption unit to provide a porous structure having a high porosity. Referring now to FIG. 21, an example of a system 2100 for conducting CO₂ capture process experiments. The system 2100 for CO₂ capture may include a gas source 2102, a moisture generator 2110, a mixing unit 2120 downstream of the moisture generator 2110, and a test chamber 2130 downstream of the mixing unit 2120. The gas source 2102 may be a source of compressed dry air. The compressed dry air may be divided into two streams. One stream may be passed to the moisture generator 2110 and the second stream may be passed directly to the mixing unit 2120. The moisture generator 2110 may be operable to increase the moisture content of the compressed dry air to produce a compressed air stream 2112 having moisture content greater than that of the compressed dry air. The compressed air stream 2112 and the second portion of the compressed dry air may be mixed in the mixing unit 2120 to produce a mixed gas stream 2122, which may be passed to the test chamber 2130. The test chamber 2130 may include a vessel 2132 and a porous structure 2134 disposed within the vessel 2132. The porous structure 2134 may be any of the porous structures described herein. The test chamber 2130 may have an outlet 2136 and a vent 2138.

The porosity of the porous structures disclosed herein may enable a greater amount of active sorbent material for CO₂ to be loaded into the adsorption/desorption unit per unit volume of honeycomb-shaped porous structure. Enabling a greater amount of sorbent material for CO₂ to be loaded per unit volume may enable a greater CO₂ adsorption capacity per unit volume for the adsorption/desorption unit compared to other types of porous media. The porous structures of the present disclosure may also have lower thermal mass compared to normal cordierite structures, which may reduce energy consumption of the CO₂ capture process by reducing the energy needed to heat the porous structure during CO₂ desorption compared to normal cordierite structures. Additionally, the porous structures disclosed herein may be less expensive compared to normal cordierite based honeycomb structures typically used in CO₂ capture processes. In embodiments, a CO₂ capture process may include an adsorption/desorption unit and the porous structure may be integrated into the adsorption/desorption unit.

Construction and arrangements of the porous structures, assemblies, and structures, as shown in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present inventive technology.

### TEST METHODS

### Modulus of Rupture

Mechanical strength of the porous structures can be evaluated using a 4-point bending point bending test conducted according to ASTM C1161. In conducting the mechanical strength testing herein, the samples are cut into 0.25 inch by 0.5 inch by 3 inch minibars. The 4-point bending test is accomplished using a 2 inch support span.

### Porosimetry

Porosity, median pore volume, and pore size distribution herein are determined using mercury intrusion porosimetry performed according to standard test methods known in the art.

### Examples

The embodiments described herein will be further clarified by the following examples. The following examples illustrate the formation of porous structures using the compositions and methods disclosed herein. The following examples are not intended to be limit the scope of the present disclosure.

### Hollow Glass Bodies

The hollow glass bodies used in the Examples of the present disclosure included two types of hollow glass bodies: H38 hollow glass microspheres and H60 hollow glass microspheres obtained from Zhongke Yali Technology Co., Ltd., China. The glass composition of the hollow glass bodies is provided below in Table 3. The H38 hollow glass microspheres refer to hollow glass microspheres having a true density of around 0.38 grams per cubic centimeter (g/cm³), and the H60 hollow glass microspheres refer to hollow glass microspheres having a true density of around 0.60 g/cm³. Throughout the Examples the abbreviation HGMS may be used to indicate hollow glass microspheres.

TABLE 3

| Chemical | | H38 Hollow Glass | H60 Hollow Glass |
|---|---|---|---|
| Component/Property | Units | Microspheres | Microspheres |
| SiO₂ | wt. % | 79.4 | 79.3 |
| CaO | wt. % | 7.72 | 7.43 |
| B₂O₃ | wt. % | 5.20 | 5.95 |
| Al₂O₃ | wt. % | 0.52 | 0.55 |
| Fe₂O₃ | wt. % | 0.057 | 0.056 |
| MgO | wt. % | 0.31 | 0.61 |
| Na₂O | wt. % | 1.68 | 1.59 |
| K₂O | wt. % | 0.14 | 0.14 |
| Softening Temperature | ° C. | ~800 | ~800 |
| True Density | g/cm³ | 0.38 | 0.60 |
| Porosity | % | 82.9 | 73.1 |
| HGMS Shell Thickness | Mm | 1.07 | 1.45 |
| Particle Size D₁₀ | μm | 20.0 | 17.0 |
| Particle Size D₅₀ | μm | 41.0 | 28.7 |
| Particle Size D₉₀ | μm | 75.0 | 58.9 |
| Distribution (D₉₀ − D₁₀)/D₅₀ | — | 1.34 | 1.46 |
| Crush Strength (psi) | psi/MPa | 3,000/20.7 | 10,000/68.9 |

### Comparative Examples 1-2: Porous Structure with No Inorganic Powder

In Comparative Example 1, a porous structure was made with a comparative composition that did not include the inorganic powder. For Comparative Examples 1 and 2, the porous structures were made with compositions comprising hollow glass bodies, a binder, oil, and water. For Comparative Example 1, the hollow glass bodies comprised the H38 hollow glass microspheres from Table 3, and for Comparative Example 2, the hollow glass bodies were the H60 hollow glass microspheres from Table 3. The binder was a methylcellulose binder. The compositions for the green structures for Comparative Examples 1 and 2 are provided in Table 4.

The composition was prepared by combining the hollow glass bodies/beads, binder, oil, and water. The composition was then formed into green structures comprising 1 inch diameter round samples. The green structures were then fired by ramping the temperature of the green structures at a constant temperature ramping rate to a peak firing temperature of 1020° C., and were maintained at 1020° C. for a period of 4 hours. After the dwell at the peak firing temperature, the green structures were cooled back to room temperature at a constant rate to produce the porous structure. The shrinkage and porosity of the porous structure produced for Comparative Examples 1 and 2 were measured and the results are reported below in Table 4. Additionally, the pore size distribution of the porous structures were determined through porosimetry as described herein and the results reported in Table 4.

TABLE 4
Composition and Properties for Green structure and
Porous Structures or Comparative Examples 1 and 2

| | | Comparative | Comparative |
|---|---|---|---|
| Constituent/Property | Units | Example 1 | Example 2 |
| Type of hollow glass body | — | H38 | H60 |
| Quantity: hollow glass | Grams | 100 | 100 |
| bodies | | | |
| Quantity of binder | Grams | 25 | 15 |
| Quantity of oil | Grams | 4 | 4 |
| Quantity of water | Grams | 145 | 100 |
| Peak Firing Temperature | ° C. | 1020 | 1020 |
| Shrinkage | Percent (%) | 18.5 | 19.2 |
| Porosity | Percent (%) | 77.3 | 74.0 |
| d₁₀ | — | 17.3 | 13.0 |
| d₅₀ | — | 22.7 | 15.0 |
| d₉₀ | — | 42.7 | 22.5 |

As shown by the data in Table 4, the porous structures of Comparative Examples 1 and 2 produced from the hollow glass bodies alone exhibited a significant degree of shrinkage of greater than 18% after firing at 1070° C. Additionally, the porous structures of Comparative Examples 1 and 2 were observed to stick with each other when stacking parts during firing. The porous structures of Comparative Examples 1 and 2 were also observed to stick with supporting refractory plates during the firing step. These sticking issues can reduce the yield rate and cause the firing cost increase.

Referring now to FIG. 4, the percent shrinkage (y-axis) as a function of the firing temperature (x-axis) for the porous structures of Comparative Example 1 (ref. no. 402) and Comparative Example 2 (ref. no. 404) is graphically depicted. As shown in FIG. 4, the greatest contributions to shrinkage occurred during glass softening at temperatures in the range of from 570° C. to 770° C. and during densification at temperatures of greater than 970° C. Very little shrinkage was observed during the crystallization phase between temperatures of from 770° C. to 970° C.

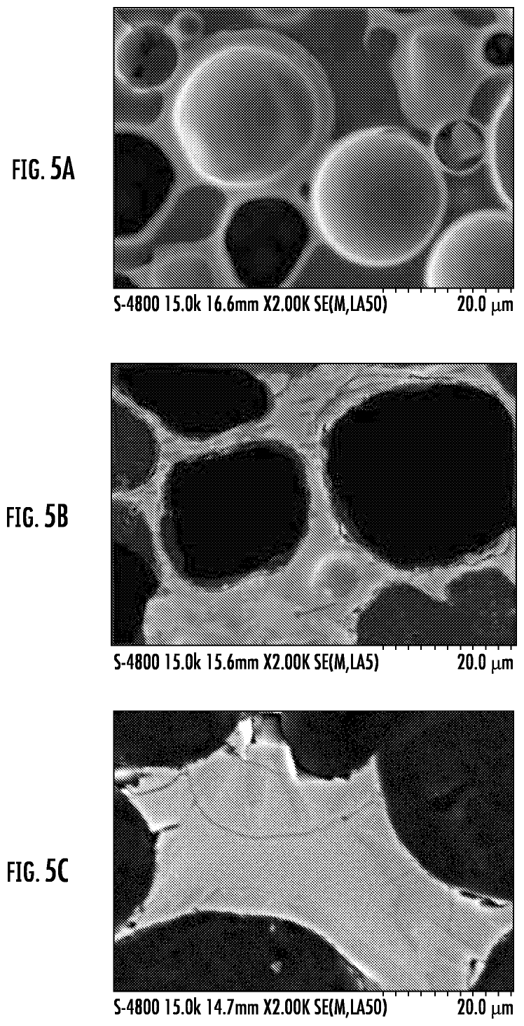

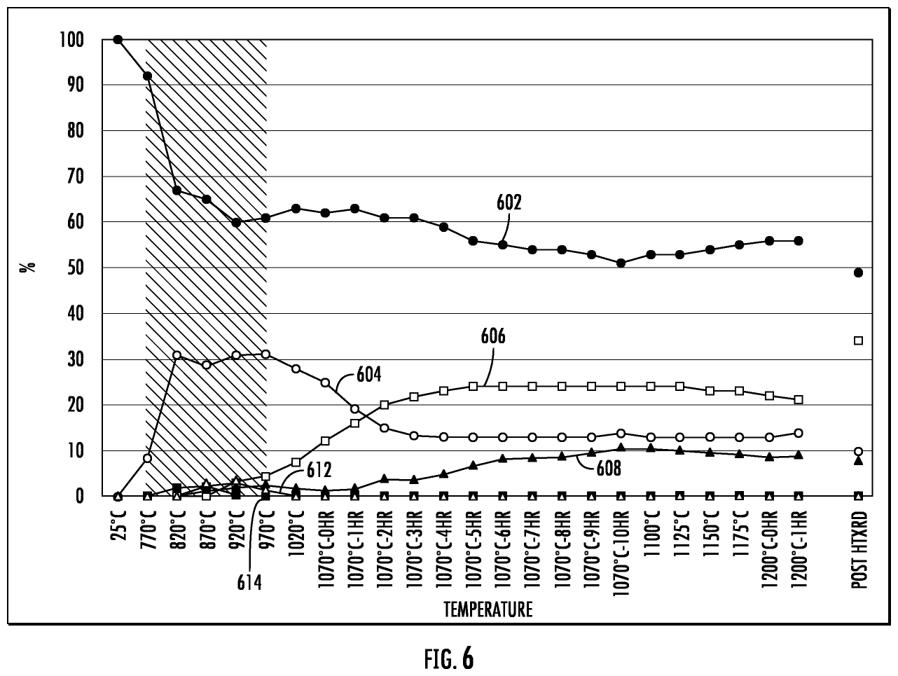

FIGS. 5A through 5C show scanning electron microscope (SEM) images of the particle morphology of the hollow glass bodies at each stage of firing for Comparative Example 2. In particular, FIG. 5A shows an SEM image of the particle morphology of the hollow glass bodies of Comp. Ex. 2 during the glass softening phase at lower temperatures. FIG. 5B shows an SEM image of the particle morphology of the hollow glass bodies during the crystallization phase for Comp. Ex. 2. FIG. 5C shows an SEM image of the particle morphology of the hollow glass bodies during densification and grain growth proximate the peak firing temperature of 1020° C. for Comparative Example 2. FIG. 6 graphically depicts the high-temperature XRD results (y-axis) as a function of firing temperature (x-axis) for the porous structure of Comparative Example 2. FIG. 6 shows that the content of the amorphous phase (ref. no. 602 in FIG. 6) decreases rapidly and crystal phases (ref. nos. 604, 606, 608, 610, and 612) increase with temperatures ramping from 770° C. to 970° C. In FIG. 6, reference no. 604 refers to the percentage of cristobalite (open circles), reference no. 606 refers to the percentage of tridymite (open squares), reference no. 608 refers to the percentage of wollastonite (solid triangles), reference no. 612 refers to the percentage of pseudowollastonite (open triangles), and reference no. 614 refers to the percentage of quartz (solid squares).

Combining FIG. 4 and FIG. 6, it was observed that the main contributions to shrinkage were mainly due to glass softening at temperatures of from 570° C. to 770° C. and densification at temperatures greater than 970° C. The relationship between shrinkage with temperature for the porous structures of Comparative Examples 1 and 2 comprising only the hollow glass bodies can be illustrated by: At temperatures of from 570° C. to 770° C., the hollow glass bodies became softened and glass flows to the neck point, which caused significant shrinkage; at temperatures of from 770° C. to 970° C., the amorphous glass phase transformed into crystal phases, which was accompanied by a slight shrinkage increase; and at temperatures of greater than 970° C., crystal grains grew accompanied by crystal phase densification, which resulted in large shrinkage increases. Thus, shrinkage of the porous structure can be reduced by suppressing shrinkage during the glass softening phase prior to crystallization and during the densification stage following crystallization.

### Example 3: Addition of Inorganic Powder Comprising Alumina as the Inorganic

### Powder Providing a Rigid Frame Member

In Example 3, an inorganic powder comprising a rigid frame member having a high melting temperature was added to hollow glass bodies to provide structural support during softening and modify the peak firing temperature to reduce shrinkage. In Example 3, the inorganic powder was added as an effective way to lessen the glass flowability at the softening stage and control the maximum firing temperature to avoid the densification stage. In Example 3, the inorganic powder was alumina (Al₂O₃) powder. The composition of Example 3 included 95 vol. % H60 hollow glass microspheres and 5 vol. % alumina, where the volume percent is defined as the true volume of the constituent divided by the sum of the true volume of the hollow glass bodies and the true volume of the inorganic powder. Binder, oil, and water were included in the composition of Example 3. The binder and oil were the same as those used in Comparative Example 2 and were included at the same weight percentages. The porous structure of Example 3 was formed by preparing the composition comprising the hollow glass bodies, Al₂O₃ inorganic powder, binder, oil, and water; forming the composition into green structures comprising 1 inch samples; and then firing the green structures at constant temperature ramping rate to the peak firing temperature of 1020° C. and maintained at 1020° C. for 4 hours. The green structures were then cooled back to room temperature at constant cooling rate.

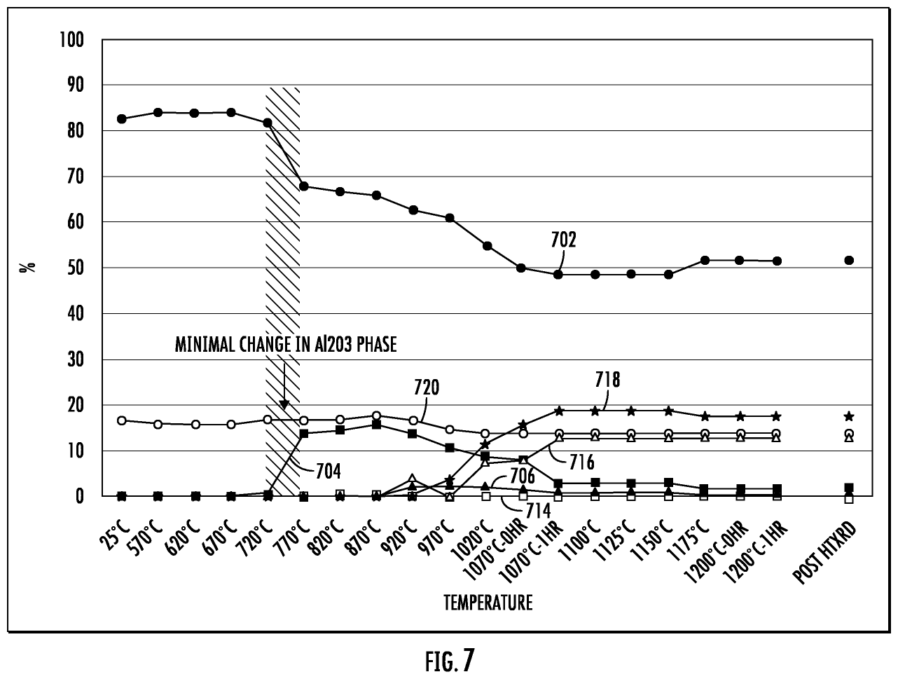

Referring now to FIG. 7, the high-temperature XRD results of the green structure comprising the composition of Example 3 with the Al₂O₃ as a function of firing temperature is graphically depicted. In FIG. 7, reference no. 702 (solid circles) refers to the percentage of amorphous phase, reference no. 704 (solid squares) refers to the percentage of cristobalite, reference no. 706 (solid triangles) refers to the percentage of tridymite, reference no. 714 (open squares) refers to the percentage of quarts, reference no. 716 (open triangles) refers to the percentage of plagioclase, reference no. 718 (solid stars) refers to the percentage of albite (NaAlSi₃O₈), and reference no. 720 (open circles) refers to the percentage of corundum. As shown in FIG. 7, the concentration of Al₂O₃ remained nearly constant during the firing process. Thus, it can be concluded that the Al₂O₃ was an inert additive during firing.

### Example 4: Addition of an Inorganic Powder Comprising Mg) as the Inorganic

### Powder Providing a Crystallizing Agent

In Example 4, an inorganic powder comprising a crystallizing agent was added to hollow glass bodies to mitigate firing shrinkage by forming new crystal phases before glass softening to reduce or prevent the effects of glass softening on the shrinkage. In Example 4, the inorganic powder was magnesium oxide (MgO). The composition of Example 4 included 95 vol. % H60 hollow glass microspheres and 5 vol. % MgO, where the volume percent is defined as the true volume of the constituent divided by the sum of the true volume of the hollow glass bodies and the true volume of the inorganic powder. Binder, oil, and water were included in the composition of Example 4. The binder and oil were the same as those used in Comparative Example 2 and were included at the same weight percentages. The porous structure of Example 4 was formed by preparing the composition comprising the hollow glass bodies, MgO inorganic powder, binder, oil, and water; forming the composition into green structures comprising 1 inch samples; and then firing the green structures at constant temperature ramping rate to the peak firing temperature of 1020° C. and maintained at 1020° C. for a period of 4 hours. The green structures were then cooled back to room temperature at constant cooling rate.

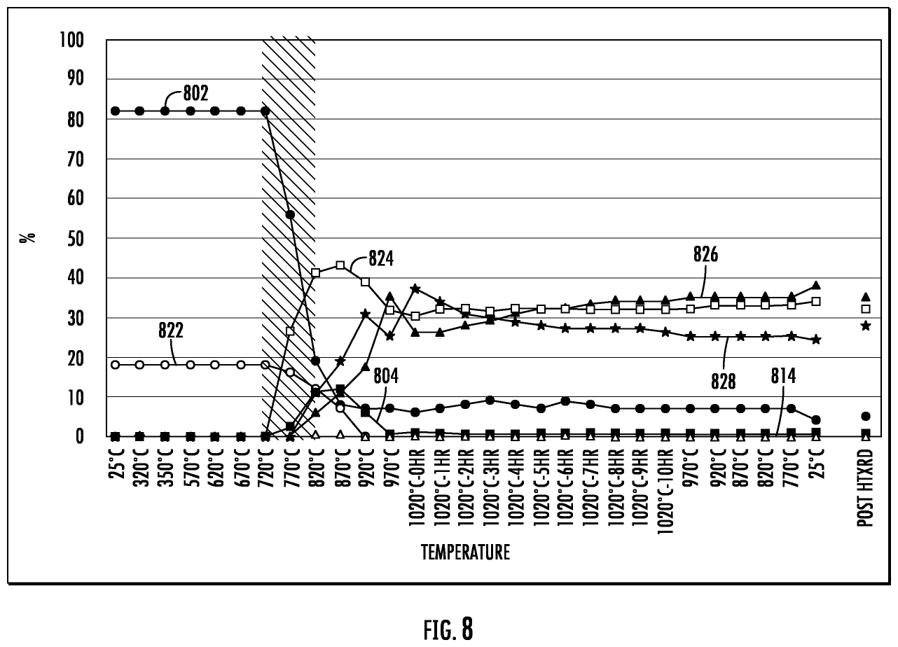

Referring now to FIG. 8, the high-temperature XRD results of the green structure comprising the composition of Example 4 with the MgO as the inorganic powder as a function of firing temperature is graphically depicted. In FIG. 8, reference no. 802 refers to the percentage of amorphous phase, reference no. 804 refers to the percentage of cristobalite, reference no. 814 refers to the percentage of quartz, reference no. 822 refers to the percentage of periclase MgO, reference no. 824 refers to the percentage of diopside (CaMgSiO₆), reference no. 826 refers to the percentage of roedderite (Na₂Mg₅Si₁₂O₃₀), and reference no. 828 refers to the percentage of clinoenstatite (MgSiO₃). As shown in FIG. 8, three new crystal phases, dioposide (CaMgSiO₆), roedderite (Na₂Mg₅Si₁₂O₃₀), and clinoenstatite (MgSiO₃), were formed during the glass softening stage. At 870° C., the amorphous content (ref. no. 802) decreased to 10%, accompanied by a large portion of hollow glass microspheres having transformed into new crystal phases. It was observed that most of the hollow glass microspheres had been opened up at this temperature of 870° C., which indicates that the peak firing temperature for the composition of Example 4 may be less than the peak firing temperature for a composition comprising only the hollow glass microspheres, such as the compositions used to make the porous structures in Comparative Examples 1 and 2.

### Example 5: Addition of an Inorganic Powder Comprising Mg(OH)₂ as the Inorganic

### Powder Providing a Crystallizing Agent

In Example 5, Mg(OH)₂ was added to the hollow glass bodies as the inorganic powder comprising a crystallizing agent to hollow glass bodies to mitigate firing shrinkage. The composition of Example 5 included 85 vol. % H60 hollow glass microspheres and 15 vol. % Mg(OH)₂, as well as the binder, oil, and water as described in Comparative Example 2 and were included at the same weight percentages. The porous structure of Example 5 was formed by preparing the composition comprising the hollow glass bodies, Mg(OH)₂ inorganic powder, binder, oil, and water; forming the composition into green structures comprising 1 inch samples; and then firing the green structures at constant temperature ramping rate to the peak firing temperature of 970° C. and maintained at 970° C. for a period of 5 hours. The green structures were then cooled back to room temperature at constant cooling rate.

The resulting porous structures comprising the Mg(OH)₂) and fired at a peak firing temperature of 970° C. was estimated to have ˜25 wt. % dioposide (CaMgSiO₆), 35 wt. % clinoenstatite (MgSiO₃), and 24 wt. % forsterite (Mg₂SiO₄). This indicates that the Mg(OH)₂ reacted with the glass of the hollow glass microspheres during the crystallization phase.

### Example 6: Addition of an Inorganic Powder Comprising Tale as the Inorganic Powder Providing a Crystallizing Agent

In Example 6, the inorganic powder added to the hollow glass bodies was talc, which was added as a crystallizing agent as in Examples 4 and 5. In Example 6, the composition included 90 vol. % H60 hollow glass microspheres and 10 vol. % talc, as well as the binder, oil and water described in Comparative Example 2. The porous structure was made according to the process described in Examples 3-5 but with a peak firing temperature of 970° C. for a period of 5 hours. The porous structure of Example 6 was estimated to have about 18 wt. % diopside, which indicates that the talc reacted with the glass of the hollow glass microspheres during the crystallization phase.

### Examples 7 and 8: Porous Structures with H38 Hollow Glass Microspheres and Inorganic Powders

In Examples 7 and 8, porous structures were prepared from compositions comprising H38 hollow glass microspheres as the hollow glass bodies. In Example 7, the inorganic powder comprised 5 vol. % alumina, which was combined with 95 vol. % H38 glass microspheres, binder, oil, and water to form the composition. In Example 8, the inorganic powder comprised 5 vol. % MgO, which was combined with 95 vol. % H38 glass microspheres, binder, and water to form the composition. The type and proportions of binder, oil, and water were the same as described above in Comparative Example 1. The compositions of Examples 7 and 8 were formed into 1 inch green structure samples, fired to a peak firing temperature of 1020° C.

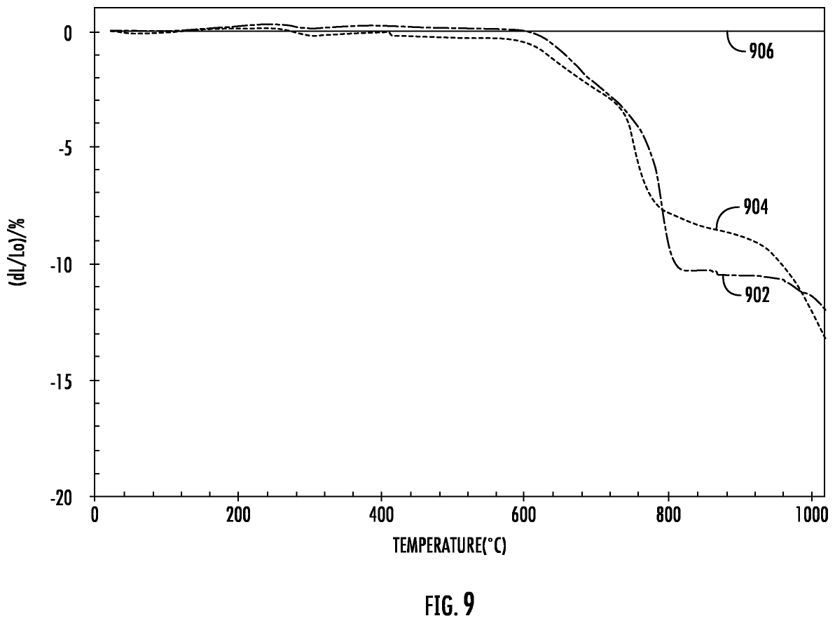

The shrinkages of the green structures of Examples 7 and 8 were evaluated during firing using a dilatometer. Referring to FIG. 9, the shrinkage as a function of temperature for the green structures of Example 7 and 8 as well as for the green structures of Comparative Example 1 (H38 glass microspheres with no inorganic powder) is graphically depicted. As shown in FIG. 9, the green structure of Comparative Example 1 (ref. no. 902) exhibited a shrinkage of greater than 10% at temperatures greater than about 800° C. In contrast, the green structure of Example 7 comprising alumina as the inorganic powder (ref. no. 904) showed improved shrinkage of less than 10% up to firing temperatures of 970° C. Without being bound by any particular theory, it is believed that the alumina acted as a rigid frame member material during the crystallization phase of the glass, thereby reducing the shrinkage during crystallization in the temperature range of from 700° C. to 800° C. The green structure of Example 8 comprising the MgO as a crystallizing agent (ref. no. 906) exhibited even less shrinkage. In fact, the green structure of Example 8 showed less than 1% shrinkage throughout the firing process.

### Example 9: Different Inorganic Powders

In Example 9, the effects of different inorganic powders on shrinkage, firing temperature, porosity and pore size were investigated. For each of Samples 9A, 9B, 9C, and 9D, a different combinations of inorganic powders and hollow glass bodies were used. For each of Samples 9A, 9B, 9C, and 9D, the compositions were prepared by combining the hollow glass bodies, inorganic powder, binder, oil, and water. The compositions were then formed into green structures and then fired to a peak firing temperature, held at the peak firing temperature for 4 hours, and then cooled back down to ambient temperature. The resulting porous structures were then evaluated for shrinkage, porosity, and pore size according to the methods described herein. The compositions, firing temperatures, and characteristics of the porous structure are provided in Table 5.

TABLE 5
Compositions and Porous Structure Properties for Example 9

| Sample | 9A | 9B | 9C | 9D |
|---|---|---|---|---|
| Type of HGMS* | H60 | H38 | H60 | H38 |
| Type of inorganic powder | MgO | CaCO₃ | Alumina | Clay** |
| Median particle size of | 1 | 7 | 8 | 7 |
| inorganic powder (μm) | | | | |
| Quantity: HGMS (g) | 90 | 46 | 100 | 100 |
| Quantity: inorganic powder (g) | 60 | 39 | 15 | 20 |
| Quantity: binder (g) | 15 | 12.5 | 15 | 10 |
| Quantity: oil (g) | 4 | 2 | 4 | 4 |
| Quantity: water (g) | 100 | 70 | 95 | 70 |
| Peak Firing Temp. (° C.) | 970 | 870 | 820 | 920 |
| Shrinkage (%) | 1.5 | 6.1 | 4.7 | 6.4 |
| Porosity (%) | 77.3 | 75.2 | 77.1 | 71.7 |
| d10 (μm) of pores | 7.6 | 1.8 | 12.5 | 6.6 |
| d50 (μm) of pores | 11.3 | 10.8 | 20.2 | 12.5 |
| d90 (μm) of pores | 13.9 | 21.3 | 45.2 | 21.3 |

*HGMS is used as an abbreviation for hollow glass microspheres.
**The clay for Sample 9D comprised 47 wt. % silica, 43.3 wt. % alumina, 1.6 wt. % titanium dioxide (TiO₂), 0.3 wt. % Fe₂O₃, and 0.1 wt. % MgO.

As shown in Table 5, the compositions of Samples 9A, 9B, 9C, and 9D all produced porous structures exhibiting less shrinkage (less than 7%) and a lesser firing temperature (less than 1000° C.) compared to the compositions and porous structures of Comparative Examples 1 and 2. Additionally, the compositions of Samples 9A, 9B, 9C, and 9D all produced porous structures exhibiting high porosity (>70%) and tunable pore size (d₅₀ of from 10.8 μm to 20.2 μm) after firing.

### Example 10: Effect of Median Particle Size of Inorganic Powder on Pore Size of Porous Structure

In Example 10, the effects of the median particle size of the inorganic powder on the porosity and median pore size of the porous structures were evaluated. In Example 10, the hollow glass bodies comprised H38 hollow glass microspheres and the inorganic powder comprised alumina at different median particle sizes. The alumina acted as a rigid frame member material within the composition. The volume percentage of inorganic powder to hollow glass bodies was maintained constant for Samples 10A, 10B, and 10C. The compositions for Samples 10A, 10B, and 10C were prepared and formed into 1 inch green structures as previously discussed and fired/cooled as previously discussed. The peak firing temperature was 870° C. The porous structures produced were then evaluated for shrinkage, porosity, and pore size distribution. The compositions and properties of the porous structures for Example 10 are provided in Table 6.

TABLE 6
Compositions and Porous Structure Properties for Example 10

| Sample | 10A | 10B | 10C |
|---|---|---|---|
| Median particle size of inorganic | 19 | 15 | 8 |
| powder (μm) | | | |
| Quantity: HGMS (g) | 52.5 | 52.5 | 51.8 |
| Quantity: inorganic powder (g) | 67.5 | 67.5 | 67.5 |
| Quantity: binder (g) | 20 | 20 | 20 |
| Quantity: oil (g) | 4 | 4 | 4 |
| Quantity: water (g) | 105 | 105 | 105 |
| Shrinkage (%) | 7.0 | 6.3 | 5.2 |
| Porosity (%) | 78.2 | 77.8 | 70.7 |
| d10 (μm) of pores | 13.2 | 8.5 | 7.2 |
| d50 (μm) of pores | 21.3 | 15.6 | 10.6 |
| d90 (μm) of pores | 37.0 | 24.2 | 24.2 |

As shown by the results in Table 6, porous structures had tunable median pore size (d₅₀) within a range of from 10.6 μm to 21.3 μm by changing the median particle size of the inorganic powder. These results demonstrate that the combination of the hollow glass bodies with the inorganic powder can further broaden the range of pore size for the porous structure through various combinations of type of hollow glass body and the median particle size of the inorganic powder.

Further, the median pore size of the porous structure can be adjusted by using different sizes of inorganic powders. Not intending to be bound by any particular theory, it is believed that the addition of inorganic powders with different particle sizes can lead to different particle packing patterns. Referring to FIG. 10A, smaller particles 1004 of the inorganic powder (e.g., 8 μm alumina of Sample 10C) may tend to fill in the packing voids between the hollow glass bodies 1002, resulting in smaller voids between hollow glass bodies 1002 and smaller median pore size in the porous structures produced therefrom. Referring to FIG. 10B, the larger particles 1006 of the inorganic powder (e.g., 19 μm alumina of Sample 10A) may tend to pack with the hollow glass bodies to generate larger voids, resulting in larger median pore size of the porous structure produced therefrom.

### Example 11: Effect of Median Particle Size of Inorganic Powder on Shrinkage

In Example 11, the effect of the median particle size of the inorganic powder on the shrinkage of the porous structures was evaluated. In Example 11, the hollow glass bodies comprised H38 hollow glass microspheres and the inorganic powder comprised alumina at different median particle sizes. The alumina acted as a rigid frame member within the composition. The volume percentage of inorganic powder to hollow glass bodies was maintained constant for Samples 11A, 11B, and 11C (12.5 vol. % inorganic powder, 87.5 vol. % hollow glass bodies). The compositions for Samples 11A, 11B, and 11C were prepared and formed into 1 inch green structures as previously discussed and fired/cooled as previously discussed. The peak firing temperature was 1020° C. The porous structures produced were then evaluated for shrinkage, porosity, and pore size distribution. The compositions and properties of the porous structures for Example 11 are provided in Table 7.

TABLE 7
Compositions and Porous Structure Properties for Example 11

| Sample | 11A | 11B | 11C |
|---|---|---|---|
| Median particle size of inorganic | 22 | 15 | 4 |
| powder (μm) | | | |
| Quantity: HGMS (g) | 52.5 | 52.5 | 51.8 |
| Quantity: inorganic powder (g) | 67.5 | 67.5 | 67.5 |
| Quantity: binder (g) | 20 | 20 | 20 |
| Quantity: oil (g) | 4 | 4 | 4 |
| Quantity: water (g) | 105 | 105 | 95 |
| Shrinkage (%) | 14.4 | 11.0 | 3.1 |
| Porosity (%) | 73.1 | 78.1 | 80.6 |
| d10 (μm) of pores | 27.2 | 19.1 | 7.2 |
| d50 (μm) of pores | 39.3 | 27.2 | 15.6 |
| d90 (μm) of pores | 90.1 | 50.0 | 22.7 |

As shown in Table 7, the inorganic powder with the smaller median particle size resulted in reduced shrinkage of the porous structure during firing. In particular, Sample 11C, which included alumina having an average pore size of 4 μm, exhibited a final shrinkage of only 3.1%. Thus reducing the particle size of the inorganic powder can further mitigate shrinkage of the porous bodies during firing, especially when the inorganic powder is a rigid frame member type inorganic powder. To further mitigate shrinkage of the porous structures, the inorganic powder may have an median particle size that is less than 0.5 times the median particle size of the hollow glass bodies, or even less than or equal to 0.2 times the median particle size of the hollow glass bodies.

### Example 12: Effect of Concentration of Inorganic Powder on the Porosity of the Porous Structure

In Example 12, the effect of the concentration of the inorganic powder in the composition on the porosity of the porous structures was evaluated. In Example 12, the hollow glass bodies comprised H38 hollow glass microspheres and the inorganic powder comprised alumina included at different proportions relative to the hollow glass bodies. Alumina with same median particle size of 15 μm was used for Samples 12A, 12B, and 12C. The alumina acted as a rigid frame member within the composition. The compositions for Samples 12A, 12B, and 12C were prepared and formed into 1 inch green structures as previously discussed and fired/cooled as previously discussed. The peak firing temperature was 1020° C. The porous structures produced after firing were then evaluated for shrinkage, porosity, and pore size distribution. The compositions and properties of the porous structures for Example 12 are provided in Table 8.

TABLE 8
Compositions and Porous Structure Properties for Example 12

| Sample | 12A | 12B | 12C |
|---|---|---|---|
| Median particle size of inorganic | 15 | 15 | 15 |
| powder (μm) | | | |
| Quantity: HGMS (g) | 30 | 45 | 52.5 |
| Vol. % HGMS (vol. %) | 50 | 75 | 87.5 |
| Quantity: inorganic powder (g) | 270 | 135 | 67.5 |
| Vol. % Inorganic Powder (vol. %) | 50 | 25 | 12.5 |
| Quantity: binder (g) | 20 | 20 | 20 |
| Quantity: oil (g) | 4 | 4 | 4 |
| Quantity: water (g) | 105 | 100 | 105 |
| Shrinkage (%) | 1.5 | 5.6 | 11.0 |
| Porosity (%) | 61.7 | 69.6 | 78.1 |
| d10 (μm) of pores | 7.2 | 9.8 | 19.1 |
| d50 (μm) of pores | 10.7 | 13.5 | 27.2 |
| d90 (μm) of pores | 36.1 | 27.1 | 50.0 |

As shown in Table 8, greater proportions of inorganic powder relative to the hollow glass bodies can reduce the shrinkage, but this also was shown to reduce porosity as well. As the content of alumina increased from 12.5 vol. % to 50 vol. % based on the true volume of the combination of the hollow glass bodies and inorganic powder, the porosity decreased from 78.1% to 61.7%. This indicates that content of inorganic powder in the composition should be less than or equal to 25 vol. %, or even less than or equal to 12.5 vol. %, in the composition based on the true volume of the combination of the hollow glass bodies and inorganic powder.

### Example 13: Effect of MgO Concentration on the Porosity and Shrinkage of the Porous Structures

In Example 13, the effect of the concentration of MgO as the inorganic powder in the composition on the porosity of the porous structures was evaluated. In Example 13, the hollow glass bodies comprised H60 hollow glass microspheres and the inorganic powder comprised MgO having a median particle size of 1 μm included at different proportions relative to the hollow glass bodies. The MgO was included as a crystallization agent type of inorganic powder. The compositions for Samples 13A, 13B, and 13C were prepared and formed into 1 inch green structures as previously discussed and fired/cooled as previously discussed. The peak firing temperature was 970° C. The porous structures produced after firing were then evaluated for shrinkage, porosity, and pore size distribution. The compositions and properties of the porous structures for Example 13 are provided in Table 9.

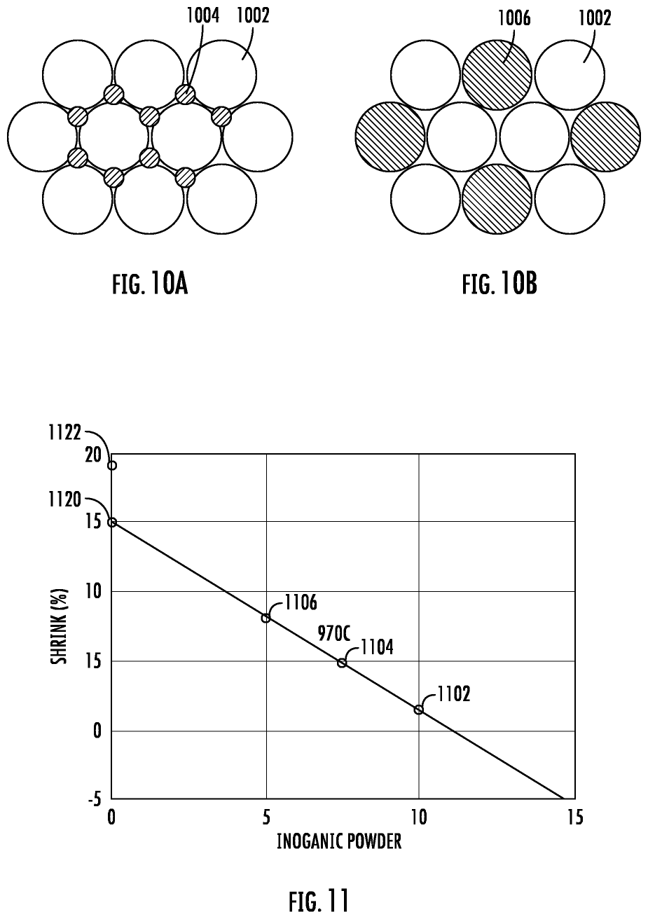

TABLE 9
Compositions and Porous Structure Properties for Example 13

| Sample | 13A | 13B | 13C |
|---|---|---|---|
| Reference No. in FIG. 11 | 1102 | 1104 | 1106 |
| Median particle size of inorganic | 1 | 1 | 1 |
| powder (μm) | | | |
| Quantity: HGMS (g) | 90 | 92.5 | 95 |
| Vol. % HGMS (vol. %) | 90 | 92.5 | 95 |
| Quantity: inorganic powder (g) | 60 | 44.8 | 30 |
| Vol. % Inorganic Powder (vol. %) | 10 | 7.5 | 5 |
| Quantity: binder (g) | 15 | 15 | 15 |
| Quantity: oil (g) | 4 | 4 | 4 |
| Quantity: water (g) | 100 | 100 | 100 |
| Shrinkage (%) | 1.5 | 4.8 | 8.1 |
| Porosity (%) | 77.3 | 79.0 | 73.4 |
| d10 (μm) of pores | 7.6 | 10.5 | 13.2 |
| d50 (μm) of pores | 11.3 | 14.3 | 18.1 |
| d90 (μm) of pores | 13.9 | 18.1 | 27.2 |

Table 9 shows the effects of the concentration of MgO on porosity of the porous structure. The MgO concentrations were all less than 12.5 vol. % based on the true volume of the combination of the hollow glass bodies and inorganic powder, and porosity of the porous structures were all greater than 70%. This further indicated that inorganic powder should be included at less than or equal to 25 vol. %, or even less than or equal to 12.5 vol. %, in the composition based on the true volume of the combination of the hollow glass bodies and inorganic powder.

Referring now to FIG. 11, the shrinkage of the porous structures compared to the green structures made from the composition (y-axis) as a function of the proportion of MgO in the composition (x-axis) is graphically depicted. The reference numbers in FIG. 9 corresponding to Samples 13A, 13B, and 13C are provided in Table 9. For comparison purposes, comparative porous structures were prepared from compositions comprising only H60 glass microspheres, binder, oil, and water and no inorganic powder (MgO). The two comparative porous structures were produced by firing at 970° C. (ref. no. 1120) and 1020° C. (ref. no. 1122). As shown in FIG. 9, the addition of the MgO as a crystallizing agent type inorganic powder to the composition can reduce the shrinkage. As the proportion of MgO in the composition increases, the shrinkage decreases, at the firing temperature of 970° C.

### Example 14: Effects of Inorganic Powder on Mechanical Strength of Porous Structures

In Example 14, the effects of including the inorganic powder in the composition on the mechanical strength of the porous structures made therefrom is evaluated. The mechanical strength was evaluated by measuring the modulus of rupture (MOR) according to the test methods disclosed herein. In particular, for MOR measurement, the compositions of Example 14 were used to prepare porous structures in the form of bars. To prepare the porous structures, four compositions were prepared and shaped into green structures. For Sample 14A, the composition included H38 hollow glass microspheres, binder, oil, and water. For Sample 14B, the composition included H60 hollow glass microspheres, binder, oil, and water. For Sample 14C, the composition included 90 vol. % H38 hollow glass microspheres, 10 vol. % CaCO₃ as the inorganic powder, binder, oil, and water. For Sample 14D, the composition included 95 vol. % H38 hollow glass microspheres, 5 vol. % MgO as the inorganic powder, binder, oil, and water. The amounts of binder, oil, and water were the same for all of Samples 14A-14D. Samples 14A, 14B, and 14C were ramped to the peak firing temperature of 1020° C. at a ramping rate of 5° C. per minute, maintained at 1020° C. for 4 hours, and the cooled back to room temperature to produce the porous structures. Sample 14D was ramped to the peak firing temperature of 970° C. at a ramping rate of 5° C. per minute, maintained at 970° C. for 4 hours, and the cooled back to room temperature to produce the porous structures. Each of Samples 14A-14D were then trimmed to produce identical shaped bars measuring 3 inches by 0.5 inches by 0.25 inches. The porous structures of Samples 14A and 14B had a cell density of 400 cells per square inch and a web thickness of 9 mils (229 micrometers). The porous structures of Samples 14C and 14D had a cell density of 300 cells per square inch and a web thickness of 9 mils (229 micrometers (μm)).

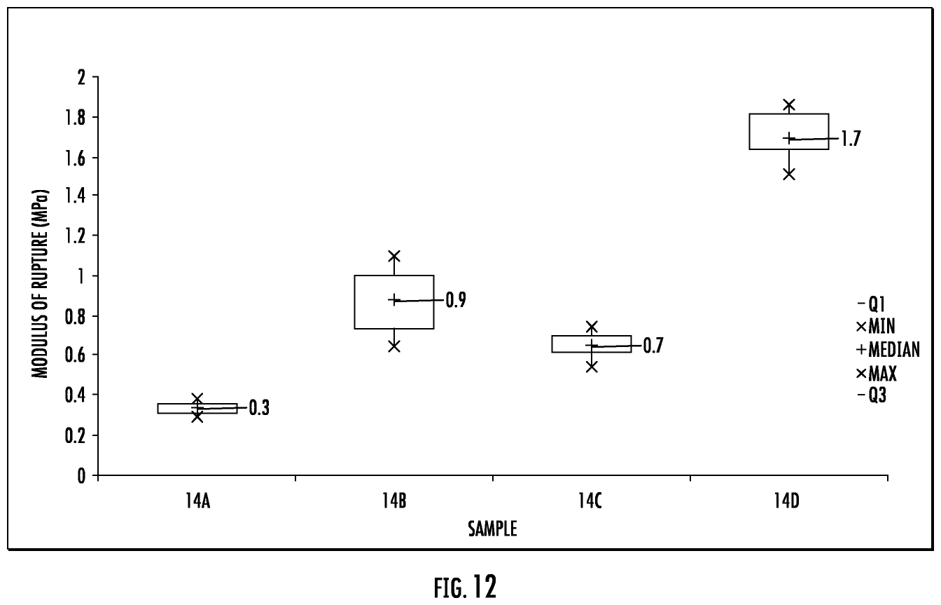

The MOR for each of the samples was measuring using a support/load span was 2.0/0.75 inches and the loading speed was 0.25 inches per minute. Multiple sample bars for each of Samples 14A-14D were evaluated and the maximum MOR, minimum MOR, median MOR, Q1 value, and Q3 value reported in FIG. 12 for each sample. FIG. 12 shows the MOR results. The MOR results indicate that combining the hollow glass bodies with the inorganic powder (H38-5% MgO of Sample 14D) can produce a porous structure having a greater MOR compared to porous structures made from hollow glass bodies without the inorganic powders (Pure H38/H60 of Samples 14A and 14B). This proved that the present composition has higher mechanical strength, which could enable making porous structures with thinner web thickness and lower cell density.

### Comparative Example 15: Effect of Firing Temperature on Shrinkage

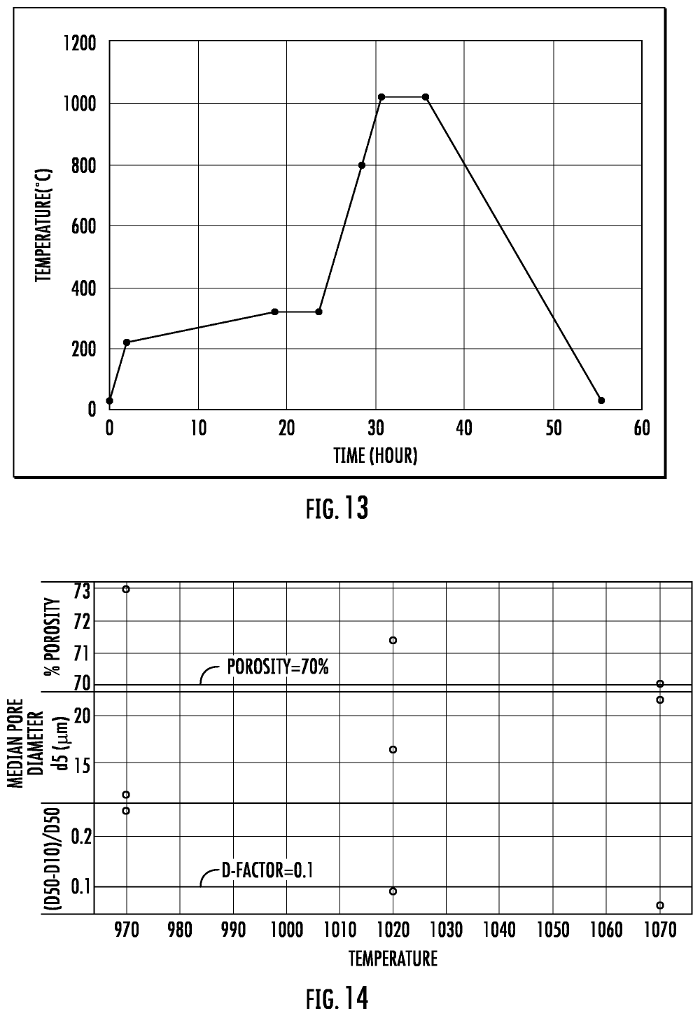

In Comparative Example 15, the effects of firing temperature on shrinkage of a porous structure comprising only the hollow glass bodies, binder, oil, and water with no inorganic powder are evaluated. In Comparative Example 15 porous structures were prepared by preparing a composition comprising H60 hollow glass microspheres, binder, oil and water, shaping the composition into green structures, and then firing the green structures at different peak firing temperatures. The green structures were small cylindrical samples having a diameter of 2 inches and a length of 4 inches. The firing was performed in a lab-scale furnace in an air atmosphere. Green structures were fired at peak firing temperatures of 970° C., 1020° C., and 1070° C. The firing cycle for firing at 1020° C. is shown in FIG. 13. As shown in FIG. 13, during firing, the temperature of the green structures was ramped to a debind temperature in a range of 200° C. to 400° C. The green structures were maintained in this debind temperature range for a debind period of about 20 hours. Then the temperature of the green structures was ramped to the peak firing temperature, maintained at the peak firing temperature for a period of about 5 hours, and then gradually cooled back to room temperature.

The porosity, median pore diameter, and pore size distribution of the porous structures produced were evaluated using mercury intrusion porosimetry according to methods disclosed herein, and the results are reported in FIG. 14. FIG. 14 shows that the peak firing temperature can influence the properties of final porous structures. The peak firing temperature can be adjusted to achieve the target attributes (e.g. porosity >70%, D-factor <=0.1). For Example 15, the peak firing temperature of 1020° C. was found to be the peak firing temperature that produced the desired properties.

### Comparative Example 16 Shrinkage During Firing Process

For Comparative Example 16, shrinkage of the green structure as a function of time and temperature during firing was investigated. For Comparative Example 16, a composition comprising H60 hollow glass microspheres, binder, oil, and water was prepared and formed into a green structure having a honeycomb shape comprising a plurality of channels through the thickness of the green structure. The green structure was then fired according to the temperature profile 1502 in FIG. 15. The shrinkage of the green structure was measured during the firing process and is shown in FIG. 15 as reference no. 1504. Referring to FIG. 15, when the temperature of the green structure reached the softening temperature, which is a temperature just less than about 700° C. for the composition of Comparative Example 16, the green structure starts to shrink and continues to shrink until it reaches the set peak firing temperature. During the cool-down process, the article doesn't further shrink. FIG. 3 shows the shrinkage of a piece of honeycomb made with H60. In this case, significant shrinkage started at a temperature just below 700° C.

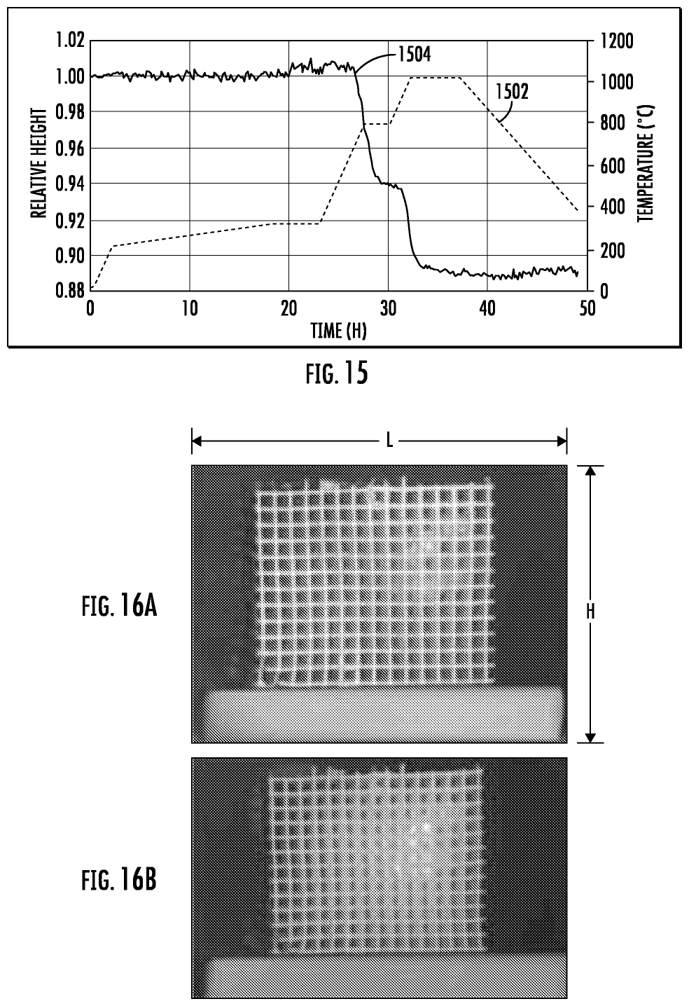

Referring now to FIG. 16A, a photograph of the honeycomb-shaped green structure of Comparative Example 16 before firing is shown. FIG. 16B shows a photograph of the honeycomb-shaped porous structure after firing the green structure of Comparative Example 16 in FIG. 16A. As shown by a comparison of FIG. 16B to 16A, the green structure experienced a significant amount of shrinkage during the firing in Comparative Example 16.

### Example 17: Effect of Temperature Ramping Rate on Shrinkage

In Example 17, the effects of changing the temperature ramping rate during the firing process on the shrinkage of the porous structures are evaluated. For Example 17, a honeycomb shaped green structure was prepared in accordance with the method previously described in Comparative Example 16. The green structure did not include any inorganic powder. The green structures of Example 17 were then fired at constant ramping rate to a peak firing temperature of 1020° C. and then cooled back to room temperature. One green structure was fired at a constant temperature ramping rate of 150° C./hour (ref. no. 1702 in FIG. 17) and another green structure was fired at a constant temperature ramping rate of 25° C./hour. (ref. no. 1704 in FIG. 17). The weight percent of crystalline phases for each of the samples was measured periodically during the firing process using high temperature X-Ray Diffraction (XRD).

Referring now to FIG. 17, the high temperature XRD results for each of the two green structures of Example 17 as a function of temperature during firing are graphically depicted. As shown in FIG. 17, in the temperature range between 670° C. and 770° C. during the heat-up process, the green structure being fired with the slow temperature ramp-up rate (ref. no. 1704) exhibited a significantly greater crystalline percentage than the one fired with the faster temperature ramp-up rate.

Based on the data in FIGS. 13 and 15, a significant amount of shrinkage occurs at temperatures between 600° C. and the peak firing temperature. 600° C. is the temperature at which significant crystallization occurs, which may result in the significant amounts of shrinkage. Slowing the temperature ramping rate in the range of from 600° C. to the peak firing temperature can result in reduced shrinkage. Also in Example 17, green structures were fired at different temperature ramping rates (25° C./hour, 50° C./hr, 100° C./hr, and 200° C./hr) and the shrinkage, porosity, median pore size, and pore size distribution of the final porous structures were evaluated. The results are shown in FIG. 18. As shown in FIG. 18, the slower temperature ramp-up rates result in reduced shrinkage. Additionally, the slower temperature ramp-up rates also provide greater porosity, larger pore size, and narrower pore size distribution, which can allow lower peak firing temperature for the same target microstructure.

### Example 18: Porous Structure Produced with Slower Temperature Ramping Rate During Crystallization Temperature Range and Dwell Period at the Top of Crystallization Temperature Range

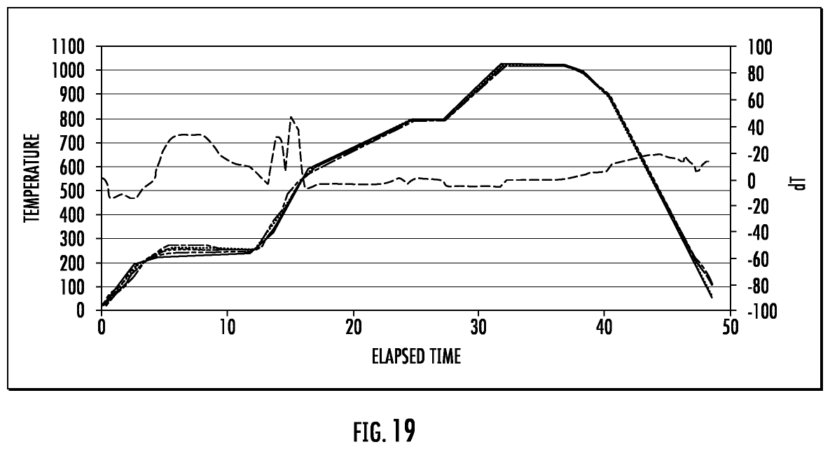

In Example 18, a porous structure was prepared by firing a green structure with a firing process that included a reduced temperature ramping rate over a temperature range of from 600° C. to 800° C. and a dwell period at 800° C., which is the upper end of the crystallization temperature range. The green structure for Example 18 was prepared from a composition comprising 49.0 wt. % H60 hollow glass microspheres, 7.4 wt. % binder, 1.0 wt. % sodium stearate, and 42.6 wt. % water. The binder was CULMINALIM MHPC 724 methylcellulose derivatives available from Ashland Specialty Chemical. The composition was prepared and the green structures were extruded with a RAM extruder with a web geometry (5.85 inch mask) having a cell density of 200 cells per square inch and a wall thickness of 8 mils. The green structures were then fired with a gas-fired kiln. The temperature setpoint and thermocouple readings as a function of time are shown in FIG. 19. The firing process featured a temperature ramp-up rate of 25° C./h between 600° C. and 800° C., a 2.5 hour soak/dwell a constant temperature of 800° C., and a temperature ramp-up rate of 50° C./h between 800° C. and 1020° C. The temperature ramping profile of Example 18 resulted in a radial shrinkage of the porous structure of 9.8%+1.1% compared to the green structure prior to firing.

### Example 19: Porous Structure Produced with Slower Temperature Ramping Rate During Crystallization Temperature Range without a Dwell Period in the Crystallization Temperature Range

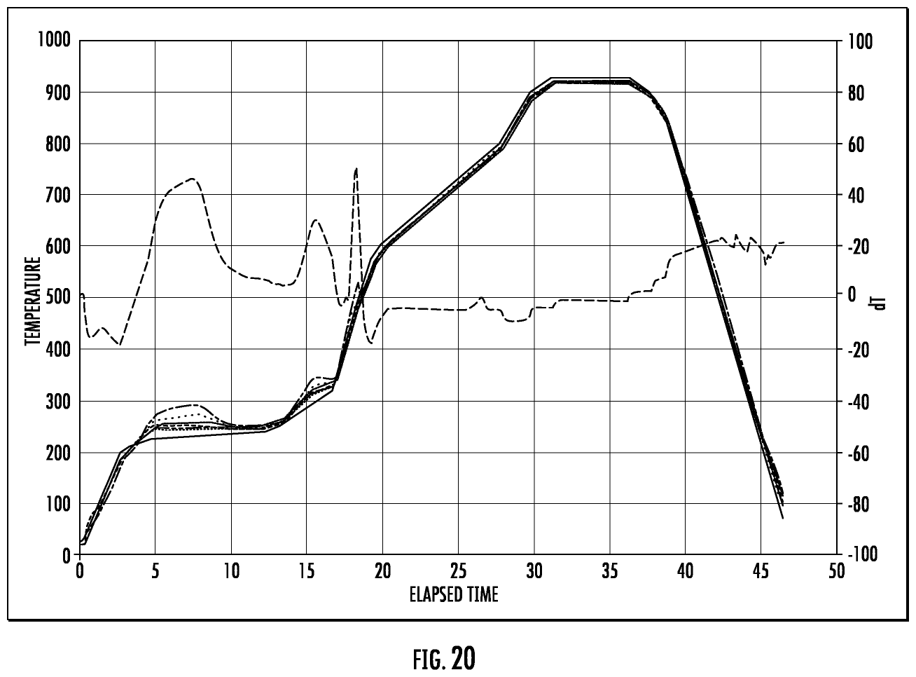

In Example 19, a porous structure was prepared by firing a green structure with a firing process that included a reduced temperature ramping rate over a temperature range of from 600° C. to 800° C. The green structure for Example 18 was prepared according to the composition and methods previously described in Example 18. The temperature setpoint and thermocouple readings for Example 19 are graphically depicted in FIG. 20. The three key differences between the firing process Example 19 and Example 18 are: (1) the peak firing temperature is 920° C. in Example 19 instead of 1020° C.; (2) the temperature profile for Example 19 does not include a soak/dwell period at 800° C.; (3) and the debind dwell period in the 220° C. to 320° C. range was longer in Example 19 compared to Example 18. For Example 19, the radial shrinkage of the porous article was 10.2%+0.4% compared to the green structure.

### Example 20: Multiple Different Sizes of Hollow Bodies

In Example 20, porous structures were prepared by firing green structures comprising various combinations of different sized hollow glass bodies to demonstrate modifying the pore size distribution of the porous structures using the combination of different hollow glass bodies. In Example 20, the green structures were formed from compositions including two different types of hollow glass bodies in combination with a binder, oil, and sodium stearate. The properties of the hollow glass bodies for Example 20 are provided in Table 10. The compositions for each of the compositions in Example 20 are provided in Table 11.

TABLE 10
Properties for hollow glass bodies of Example 20

| Hollow glass bodies | H60 | 34P30 | 45P25 | CTB75 |
|---|---|---|---|---|
| True Density (g/cm³) | 0.60 | 0.34 | 0.45 | 0.45-0.8 |
| D10 (μm) | 17.0 | 20 | 12 | — |
| D50 (μm) | 28.7 | 38 | 21 | — |
| D90 (μm) | 58.9 | 60 | 34 | — |
| Mean Particle Diameter (μm) | — | — | — | 55 |
| Particle Size Range (μm) | — | — | — | 12-75 |

TABLE 11
Compositions of Green Structures for Example 20

| | | | | | Corn | | | Sodium |
|---|---|---|---|---|---|---|---|---|
| | H60 | 34P30 | 45P25 | CTB75 | Starch | Binder | Oil | Stearate |
| Constituent | (vol. %) | (vol. %) | (vol. %) | (vol. %) | (vol. %) | (vol. %) | (vol. %) | (vol. %) |
| 20-1 | — | 50 | — | 50 | 40 | 10 | 2 | 2 |
| 20-2 | — | 50 | — | 50 | 40 | 10 | 2 | 2 |
| 20-3 | — | 50 | — | 50 | 40 | 10 | 2 | 2 |
| 20-4 | — | 50 | — | 50 | 40 | 10 | 2 | 2 |
| 20-5 | — | 50 | — | 50 | 40 | 10 | 2 | 2 |
| 20-6 | — | 50 | — | 50 | 40 | 10 | 2 | 2 |
| 20-7 | — | — | 50 | 50 | 40 | 10 | 2 | 2 |
| 20-8 | — | — | 50 | 50 | 40 | 10 | 2 | 2 |
| 20-9 | — | — | 50 | 50 | 40 | 10 | 2 | 2 |
| 20-10 | — | — | 50 | 50 | 40 | 10 | 2 | 2 |
| 20-11 | — | — | 50 | 50 | 40 | 10 | 2 | 2 |
| 20-12 | — | — | 50 | 50 | 40 | 10 | 2 | 2 |
| 20-13 | 50 | — | — | 50 | 40 | 10 | 4 | 2 |
| 20-14 | 50 | — | — | 50 | 40 | 10 | 4 | 2 |
| 20-15 | 50 | — | — | 50 | 40 | 10 | 4 | 2 |
| 20-16 | 50 | 50 | — | — | — | 15 | 4 | 2 |
| 20-17 | 50 | 50 | — | — | — | 15 | 4 | 2 |
| 20-18 | 50 | 50 | — | — | — | 15 | 4 | 2 |
| 20-19 | 50 | 50 | — | — | — | 15 | 4 | 2 |
| 20-20 | 50 | — | 50 | — | — | 15 | 4 | 2 |
| 20-21 | 50 | — | 50 | — | — | 15 | 4 | 2 |
| 20-22 | 50 | — | 50 | — | — | 15 | 4 | 2 |
| 20-23 | 50 | — | 50 | — | — | 15 | 4 | 2 |
| 20-24 | 50 | — | 50 | — | — | 15 | 4 | 2 |

The green structures were then fired by ramping the temperature of the green structures to a peak firing temperature, holding the green structures at the peak firing temperature for a dwell time, and then ramping the firing temperature back down to ambient temperature. The resulting porous structures were then evaluated for porosity and pore size distribution according to the methods disclosed herein. The peak firing temperatures for the green structures and the properties of the resulting porous structures are provided in Table 12.

TABLE 12
Properties of the Porous Structures of Example 20 After Firing

| | Peak Firing | Porosity | d10 | d50 | d90 | (d50 − d10)/ |
|---|---|---|---|---|---|---|
| Property | Temp. (° C.) | (%) | (μm) | (μm) | (μm) | d50 |
| 20-1 | 570 | 81.7 | 0.02 | 7.09 | 12.52 | 1.00 |
| 20-2 | 620 | 77.8 | 0.02 | 7.24 | 10.54 | 1.00 |
| 20-3 | 670 | 76.4 | 0.02 | 7.86 | 10.98 | 1.00 |
| 20-4 | 720 | 72.6 | 1.90 | 10.43 | 16.76 | 0.82 |
| 20-5 | 820 | 71.2 | 3.68 | 11.67 | 16.77 | 0.68 |
| 20-6 | 920 | 68.1 | 8.70 | 15.69 | 23.79 | 0.45 |
| 20-7 | 570 | 76.4 | 0.01 | 4.63 | 7.07 | 1.00 |
| 20-8 | 620 | 75.2 | 0.01 | 4.62 | 6.58 | 1.00 |
| 20-9 | 670 | 71.8 | 0.01 | 5.09 | 7.64 | 1.00 |
| 20-10 | 720 | 68.1 | 0.02 | 5.28 | 7.25 | 1.00 |
| 20-11 | 820 | 68.2 | 2.26 | 6.79 | 8.48 | 0.67 |
| 20-12 | 920 | 65.6 | 6.74 | 10.11 | 16.04 | 0.33 |
| 20-13 | 870 | 80.0 | 0.01 | 13.37 | 19.05 | 1.00 |
| 20-14 | 970 | 77.6 | 5.06 | 15.40 | 21.46 | 0.67 |
| 20-15 | 1020 | 68.5 | 9.81 | 18.26 | 28.80 | 0.46 |
| 20-16 | 970 | 51.0 | 9.34 | 11.15 | 17.00 | 0.16 |
| 20-17 | 1020 | 52.2 | 13.59 | 15.90 | 25.28 | 0.15 |
| 20-18 | 1070 | 32.9 | 17.18 | 20.86 | 52.79 | 0.18 |
| 20-19 | 1120 | 3.9 | 0.01 | 64.02 | 236.85 | 1.00 |
| 20-20 | 870 | 48.9 | 0.00 | 0.01 | 4.90 | 0.54 |
| 20-21 | 970 | 51.7 | 8.63 | 10.86 | 16.78 | 0.21 |
| 20-22 | 1020 | 53.0 | 12.86 | 15.60 | 20.22 | 0.18 |
| 20-23 | 1070 | 41.7 | 16.28 | 18.62 | 26.41 | 0.13 |
| 20-24 | 1120 | 24.2 | 16.95 | 21.69 | 81.64 | 0.12 |

As shown in Table 12, using different combinations of hollow bodies can change the porosity, peak firing temperature, and/or pore size distribution of the resulting porous structures. Thus, the porosity and pore size distribution of the porous structure can be modified by incorporating hollow glass bodies of different sizes, glass compositions, and wall thicknesses and changing the volume ratio of each different type of the hollow glass bodies.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A composition for producing porous structures, the composition comprising:
from 5 wt. % to 95 wt. % hollow glass bodies;
from 5 wt. % to 95 wt. % inorganic powder, wherein the wt. % is based on the total combined weight of the hollow glass bodies and the inorganic powder;
at least one binder; and
water.

2. The composition of claim 1, comprising from 50 vol. % to 99 vol. % hollow glass bodies and from 1 vol. % to 50 vol. % inorganic powder based on the combined true volume of the hollow bodies and the inorganic powder.

3. The composition of claim 1, wherein the inorganic powder: (i) has a median particle size of less than or equal to 0.5 times a median particle size of the hollow bodies; or (ii) comprises a single inorganic powder that acts as one or more of a rigid frame material, a crystallization agent, a reactive agent, or combinations of these.

4. (canceled)

5. The composition of claim 1, wherein the inorganic powder comprises a rigid frame material, a crystallizing agent, reactive agent, or a combination of these.

6. The composition of claim 5, wherein the inorganic powder includes a rigid frame material comprising one or more powders selected from the group consisting of alumina, silica, titania, zirconia, cordierite, mullite, spinel, forsterite, wollastonite, clinoenstatite, diopside, zircon, sapphirine, clay, SiC, Al₄C₃, ZrC, Si₃N₄, AlN, and combinations of these.

7. The composition of claim 5, wherein the inorganic powder comprises a rigid frame material that is capable of maintaining its original particle shape at temperatures: (i) greater than the softening temperature of the hollow bodies, has a melt temperature greater than the softening temperature of the hollow bodies, or both; or (ii) greater than the crystallization temperature of the hollow bodies, has a has a melt temperature greater than the crystallization temperature of the hollow bodies, or both.

8. (canceled)

9. The composition of claim 5, wherein the inorganic powder includes a crystallizing agent or a reactive agent: (i) capable of reacting with the glass of the hollow bodies to form new crystal phases at temperatures less than a softening temperature of the hollow bodies; or (ii) comprising one or more powders selected from the group consisting of MgO, Mg(OH)₂, CaO, K₂O, Na₂O, KOH, NaOH, CaCO₃, B₂O₃, B(OH)₃, BN, B₄C, TiO₂, talc, clay, forsterite, wollastonite, clinoenstatite, diopside and combinations of these.

10. (canceled)

11. The composition of claim 1, wherein the hollow bodies: (i) comprise silica glass microspheres; or (ii) have a D50 of from 1 μm to 100 μm and a size distribution of less than 0.8, where the size distribution is defined as the quotient of (D50−D10)/D50; or (iii) have a wall thickness of from 0.2 μm to 10 μm.

12. (canceled)

13. (canceled)

14. The composition of claim 1, wherein the composition has a peak firing temperature less than or equal to 1400° C.

15. A porous structure prepared from the composition of claim 1.

16. The porous structure of claim 15, comprising:
from 5 wt. % to 95 wt. % glass based on the total weight of the porous structure; and
from 5% to 95% inorganic powder based on the total weight of the porous structure.

17. The porous structure of claim 15, wherein the porous structure comprises a size and shape within 15% of a size and shape of a green structure comprising the composition prior to firing.

18. A porous structure comprising:
from 5 wt. % to 95 wt. % hollow bodies comprising silica glass based on the total weight of the porous structure; and
from 5 wt. % to 95 wt. % inorganic powder based on the total weight of the porous structure, wherein:
the hollow bodies and inorganic powder are sintered together;
at least a portion of the hollow bodies are breached;
voids defined within the individual breached hollow bodies open into one another to form cavities that extend through the porous structure and to outer surfaces thereof; and
the porous structure has at least 50% porosity by volume.

19. The porous structure of claim 18, wherein the porous structure has a D-factor of less than or equal to 0.5, wherein:
the D-factor is equal to (d₅₀−d₁₀)/d₅₀;
d₅₀ refers to a mean pore diameter of the porous structure at which 50% by volume of the open porosity of the porous structure has been intruded by mercury during a porosimetry measurement; and
d₁₀ is equal to the pore diameter at which 90% by volume of the open porosity of the porous structure has been intruded by mercury during a porosimetry measurement.

20. The porous structure of claim 18, wherein the porous structure has a median pore size of from 1 μm to 50 μm, or from 8 μm to 20 μm, a porosity of from 50% to 85%, or both.

21. The porous structure of claim 18, wherein the porous structure has a honeycomb shape comprising a plurality of elongate channels extending through at least a portion of the porous structure, wherein the porous structure has a cell density of less than 400 cells per inch and a web thickness between cells of from 2 mils to 8 mils, where the cell density refers to a number of elongate channels per square inch of cross-section of the porous structure.

22. A filter comprising:
the porous structure of claim 18;
a coating supported by the porous structure, wherein the coating is configured to influence, block, and/or attract target particulates; and
a housing at least in part surrounding the porous structure and the coating.

23. A CO₂ capture process comprising the porous structure of claim 18, wherein the CO₂ capture process comprises an adsorption/desorption unit and the porous structure is integrated into the adsorption/desorption unit.

24. A method for making a porous structure, the method comprising:
preparing a composition comprising hollow glass bodies, an inorganic powder, a binder, and water;
forming a green structure from the composition;
firing the green structure, wherein firing the green structure bonds the hollow bodies and inorganic powder together and breaches at least a portion of the hollow bodies to form the porous structure having a size and shape that is within 15%, or even within 1% of a size and shape of the green structure before firing.

25. The method of claim 24, further comprising: (i) tuning an average pore size of the porous structure by changing a proportion of the inorganic powder to the hollow bodies in the composition; or (ii) changing the porosity of the porous structure by changing an amount of the inorganic powder in the composition.

26. (canceled)

27. The method of claim 24, comprising firing the green structure at a peak firing temperature less than or equal to 1400° C., wherein firing the green structure at the peak firing temperature comprises:
ramping the green structure to the peak firing temperature; and
holding the green structure at the peak firing temperature for a period of from 1 hour to 10 hours.

28. The method of claim 24, wherein firing comprises holding the green structure at a crystallization temperature of the glass or slowing a temperature ramping rate of the green structure at the crystallization temperature of the glass.

29. The method of claim 24, wherein firing the green structure comprises:
de-binding the green structure in a temperature range of from 200° C. to 400° C.;
ramping the temperature of the green structure to a crystallization temperature of the hollow bodies at a first ramping rate of from 50° C. per hour to 300° C. per hour;
at a crystallization start temperature, slowing the temperature ramp rate to a second ramping rate of less than 100° C. per hour or holding the temperature at the crystallization start temperature for a time period of 1 hour to 10 hours; wherein slowing the ramping rate at the crystallization start temperature or holding the green structure at the crystallization start temperature reduces shrinkage of the porous structure compared to the green structure;
ramping the green structure to a peak firing temperature of the green structure; and
maintaining the green structure at the peak firing temperature for a period of from 1 hour to 10 hours.
